(19) United States
(12) Patent Application Publication
(10) Pub. No.: US 2002/0059544 A1
(43) Pub. Date: May 16, 2002

(54) Methods and systems for determining and displaying activities of concurrent processes

(76) Inventors: Michael L. Boucher, Lafayette, CO (US); Kristopher Richards, Fort Collins, CO (US); Jeremy C. Week, Broomfield, CO (US)

Correspondence Address: SONNENSCHEIN NATH & ROSENTHAL, P.O. BOX 061080, WACKER DRIVE STATION, CHICAGO, IL, 60606-1080, US

(21) Appl. No.: 10/002,885

(22) Filed: Nov. 2, 2001

Related U.S. Application Data
(63) Continuation-in-part of application No. 09/244,895, filed on Feb. 4, 1999.

(51) Int. Cl. G06F 11/36

(52) U.S. Cl. 714/38

(57) ABSTRACT

Methods, systems and articles of manufacture consistent with the present invention determine the state of each thread when a selected thread is in a selected state, and quantify this information during a measuring period. Methods, systems and articles of manufacture consistent with the present invention also determine the state of each thread when any of the threads is in a selected state, and quantify this information during a measuring period.

### CROSS-REFERENCE TO RELATED APPLICATIONS

The following identified U.S. patent applications are relied upon and are incorporated by reference in this application:

U.S. patent application Ser. No. 09/244,895, entitled “Methods, Systems, and Articles of Manufacture for Analyzing Performance of Application Programs,” bearing attorney docket no. 6502.0203, and filed on Feb. 4, 1999.

### FIELD OF THE INVENTION

The present invention relates generally to performance analysis and more specifically to methods for providing a multi-dimensional view of performance data associated with an application program.

### BACKGROUND OF THE INVENTION

Multi-threading is the partitioning of an application program into logically independent “threads” of control that can execute in parallel. Each thread includes a sequence of instructions and data used by the instructions to carry out a particular program task, such as a computation or input/output function. When employing a data processing system with multiple processors, i.e., a multiprocessor computer system, each processor executes one or more threads depending upon the number of processors to achieve multi-processing of the program.

A program can be multi-threaded and still not achieve multi-processing if a single processor is used to execute all threads. While a single processor can execute instructions of only one thread at a time, the processor can execute multiple threads in parallel by, for example, executing instructions corresponding to one thread until reaching a selected instruction, suspending execution of that thread, and executing instructions corresponding to another thread, until all threads have completed. In this scheme, as long as the processor has started executing instructions for more than one thread during a given time interval all executing threads are said to be “running” during that time interval.

Multiprocessor computer systems are typically used for executing application programs intended to address complex computational problems in which different aspects of a problem can be solved using portions of a program executing in parallel on different processors. A goal associated with using such systems to execute programs is to achieve a high level of performance, in particular, a level of performance that reduces the waste of the computing resources. Computer resources may be wasted, for example, if processors are idle (i.e., not executing a program instruction) for any length of time. Such a wait cycle may be the result of one processor executing an instruction that requires the result of a set of instructions being executed by another processor. Thus, although multiprocessor computer systems generally make a program run faster, the efficiency of multiprocessor computer systems is usually less than 100%, which means that a program run in parallel on two processors usually does not run twice as fast or in half the time. This inefficiency is caused by many factors including parts of a program that cannot use all available processors, overhead of establishing and managing parallel execution, and conflicts between processors. To minimize the effects of the factors that decrease efficiency, it is helpful to understand how the processors interact with each other during execution. It is especially desirable to understand what other processors are doing when one or more processors enter a state that exhibits a high degree of poor performance. To that end, it is helpful to have a method or system that will determine what other processors are doing when one or more processors enters such a state.

It is thus necessary to analyze performance of programs executing on such data processing systems to determine whether optimal performance is being achieved. If not, areas for improvement should be identified.

Performance analysis in this regard generally requires gathering information in three areas. The first considers the processor's state at a given time during program execution. A processor's state refers to the portion of a program (for example, set of instructions such as a subprogram, loop, or other code block) that the processor is executing during a particular time interval. The second considers how much time a processor spends in transition from one state to another. The third considers how close a processor is to executing at its peak performance. These three areas do not provide a complete analysis, however. They fail to address a fourth component of performance analysis, namely, precisely what a processor did during a particular state (e.g., computation, input data, output data, etc.).

When considering what a processor did while in a particular state, a performance analysis tool can determine the affect of operations within a state on the performance level. Once these factors are identified, it is possible to synchronize operations that have a significant impact on performance with operations that have a less significant impact, and achieve a better overall performance level. For example, a first thread may perform an operation that uses significant resources while another thread scheduled to perform a separate operation in parallel with the first thread sits idle until the first thread completes its operation. It may be desirable to cause the second thread to perform a different operation that does not require the first thread to complete its operation, thus eliminating the idle period for the second thread. By changing the second thread's schedule in this way the operations performed by both threads are better synchronized.

When a performance analysis tool reports a problem occurring in a particular state, but fails to relate the problem to other events occurring in an application (for example, operations of another state), the information reported is relatively meaningless. To be useful a performance analysis tool must assist a developer in determining how performance information relates to a program's execution. Therefore, allowing a developer to determine the context in which a performance problem occurs provides insight into diagnosing the problem.

The process of gathering this information for performance analysis is referred to as “instrumentation.” Instrumentation generally requires adding instructions to a program under examination so that when the program is executed the instructions generate data from which the performance information can be derived.

Current performance analysis tools gather data in one of two ways: subprogram level instrumentation and bucket level instrumentation. A subprogram level instrumentation method of performance analysis tracks the number of subprogram calls by instrumenting each subprogram with a set of instructions that generate data reflecting calls to the subprogram. It does not allow a developer to track performance data associated with the operations performed by each subprogram or a specified portion of the subprogram, for example, by specifying data collection beginning and ending points within a subprogram.

A bucket level instrumentation performance analysis tool divides the executable code into evenly spaced groups, or buckets. Performance data tracks the number of times a program counter was in a particular bucket at the conclusion of a specified time interval. This method of gathering performance data essentially takes a snapshot of the program counter at the specified time interval. This method fails to provide comprehensive performance information because it only collects data related to a particular bucket during the specified time interval.

The current performance analysis methods fail to provide customized collection or output of performance data. Generally, performance tools only collect a pre-specified set of data to display to a developer.

### SUMMARY OF THE INVENTION

Methods, systems, and articles of manufacture consistent with the present invention overcome the shortcomings of the prior art by facilitating performance analysis of multi-threaded programs executing in a data processing system. Such methods, systems, and articles of manufacture analyze performance of threads executing in a data processing system by receiving data reflecting a state of each thread executing during a measurement period, and displaying a performance level corresponding to the state of each thread during the measurement period.

Event-based data is gathered that allows reconstruction of the execution state of each thread running a program at the time of interest. At any given time, all threads of execution are said to be in some state. A state is a block of code executed for some reason. The most common case is that there is a one-to-one mapping between blocks of code and states, so that whenever a process is executing that block of code, it is said to be in that state and whenever a process is in that state, it is executing in that block of code. There may also be a many-to-one mapping of blocks associated with the state. Moreover, there may be a one-to-many mapping of blocks of code to states so that a process executing a particular block of code may be in one of many states depending on other factors. Finally, there may be a many-to-many mapping of blocks of code to states.

When a process is in a particular state, it is helpful to know what states other processes are in at the time that it is in the state in question. The proposed invention determines and graphically and textually presents that information to a user. In addition, methods and systems consistent with the present invention quantify this information to make it convenient for the user.

In accordance with methods consistent with the present invention, a method is provided in a data processing system having a program with a plurality of threads having a plurality of states. The program executes during a measuring period and the measuring period comprises a plurality of time intervals. The method comprises the steps of receiving user input indicating one of the plurality of states to anchor, receiving user input indicating a selected one of the plurality of threads, determining a portion of the measuring period during which the selected thread is in the anchored state, determining, during the portion of the measuring period, whether another thread other than the selected thread is in another state other than the anchored state, and when it is determined that the other thread is in the other state, determining an amount of time that the other thread is in the other state.

In accordance with methods consistent with the present invention, a method is provided in a data processing system having a program with a plurality of threads having a plurality of states. The program executes during a measuring period and the measuring period comprises a plurality of time intervals. The method comprises the steps of receiving user input indicating one of the plurality of states to anchor, receiving user input indicating a selected one of the plurality of threads, determining a portion of the measuring period during which the selected thread is in the anchored state, determining, during the portion of the measuring period, whether another thread other than the selected thread is in the anchored state, and when it is determined that the other thread is in the anchored state, determining an amount of time that the other thread is in the anchored state.

In accordance with methods consistent with the present invention, a method is provided in a data processing system having a program with a plurality of threads having a plurality of states. The program executes during a measuring period and the measuring period comprises a plurality of time intervals. The method comprises the steps of receiving user input indicating a selected one of the plurality of states, receiving user input indicating a selected one of the plurality of threads, and determining a portion of the measuring period during which the selected thread is in the selected state.

In accordance with methods consistent with the present invention, a method is provided in a data processing system having a program with a plurality of threads having a plurality of states. The program executes during a measuring period and the measuring period comprises a plurality of time intervals. The method comprises the steps of receiving user input indicating one of the plurality of states to anchor, determining a portion of the measuring period during which any of the plurality of threads is in the anchored state, determining, during the portion of the measuring period, whether a selected one of the plurality of threads is in another state other than the anchored state, and when it is determined that the selected thread is in the other state, determining an amount of time that the selected thread is in the other state.

In accordance with methods consistent with the present invention, a method is provided in a data processing system having a program with a plurality of threads having a plurality of states. The program executes during a measuring period and the measuring period comprises a plurality of time intervals. The method comprises the steps of receiving user input indicating one of the plurality of states to anchor, determining a portion of the measuring period during which any of the plurality of threads is in the anchored state, determining, during the portion of the measuring period, whether a selected one of the plurality of threads is in the anchored state, and when it is determined that the selected thread is in the anchored state, determining an amount of time that the selected thread is in the anchored state.

In accordance with methods consistent with the present invention, a method is provided in a data processing system having a program with a plurality of threads having a plurality of states. The program executes during a measuring period and the measuring period comprises a plurality of time intervals. The method comprises the steps of receiving user input indicating a selected one of the plurality of states, and determining a portion of the measuring period during which any of the plurality of threads is in the selected state.

In accordance with articles of manufacture consistent with the present invention, a computer-readable medium is provided. The computer-readable medium contains instructions for controlling a data processing system to perform a method. The data processing system has a program with a plurality of threads having a plurality of states. The program executes during a measuring period and the measuring period comprises a plurality of time intervals. The method comprises the steps of receiving user input indicating one of the plurality of states to anchor, receiving user input indicating a selected one of the plurality of threads, determining a portion of the measuring period during which the selected thread is in the anchored state, determining, during the portion of the measuring period, whether another thread other than the selected thread is in another state other than the anchored state, and when it is determined that the other thread is in the other state, determining an amount of time that the other thread is in the other state.

In accordance with articles of manufacture consistent with the present invention, a computer-readable medium is provided. The computer-readable medium contains instructions for controlling a data processing system to perform a method. The data processing system has a program with a plurality of threads having a plurality of states. The program executes during a measuring period and the measuring period comprises a plurality of time intervals. The method comprises the steps of receiving user input indicating one of the plurality of states to anchor, receiving user input indicating a selected one of the plurality of threads, determining a portion of the measuring period during which the selected thread is in the anchored state, determining, during the portion of the measuring period, whether another thread other than the selected thread is in the anchored state, and when it is determined that the other thread is in the anchored state, determining an amount of time that the other thread is in the anchored state.

In accordance with articles of manufacture consistent with the present invention, a computer-readable medium is provided. The computer-readable medium contains instructions for controlling a data processing system to perform a method. The data processing system has a program with a plurality of threads having a plurality of states. The program executes during a measuring period and the measuring period comprises a plurality of time intervals. The method comprises the steps of receiving user input indicating a selected one of the plurality of states, receiving user input indicating a selected one of the plurality of threads, and determining a portion of the measuring period during which the selected thread is in the selected state.

In accordance with articles of manufacture consistent with the present invention, a computer-readable medium is provided. The computer-readable medium contains instructions for controlling a data processing system to perform a method. The data processing system has a program with a plurality of threads having a plurality of states. The program executes during a measuring period and the measuring period comprises a plurality of time intervals. The method comprises the steps of receiving user input indicating one of the plurality of states to anchor, determining a portion of the measuring period during which any of the plurality of threads is in the anchored state, determining, during the portion of the measuring period, whether a selected one of the plurality of threads is in another state other than the anchored state, and when it is determined that the selected thread is in the other state, determining an amount of time that the selected thread is in the other state.

In accordance with articles of manufacture consistent with the present invention, a computer-readable medium is provided. The computer-readable medium contains instructions for controlling a data processing system to perform a method. The data processing system has a program with a plurality of threads having a plurality of states. The program executes during a measuring period and the measuring period comprises a plurality of time intervals. The method comprises the steps of receiving user input indicating one of the plurality of states to anchor, determining a portion of the measuring period during which any of the plurality of threads is in the anchored state, determining, during the portion of the measuring period, whether a selected one of the plurality of threads is in the anchored state, and when it is determined that the selected thread is in the anchored state, determining an amount of time that the selected thread is in the anchored state.

In accordance with articles of manufacture consistent with the present invention, a computer-readable medium is provided. The computer-readable medium contains instructions for controlling a data processing system to perform a method. The data processing system has a program with a plurality of threads having a plurality of states. The program executes during a measuring period and the measuring period comprises a plurality of time intervals. The method comprises the steps of receiving user input indicating a selected one of the plurality of states, and determining a portion of the measuring period during which any of the plurality of threads is in the selected state.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 depicts a data processing system suitable for implementing a performance analysis system consistent with the present invention;

FIG. 2 depicts a block diagram of a performance analysis system operating in accordance with methods, systems, and articles of manufacture consistent with the present invention;

FIG. 3 depicts a flow chart illustrating operations performed by a performance analysis system consistent with an implementation of the present invention;

FIG. 4 depicts a multi-dimensional display of the performance data associated with an application program that has been instrumented in accordance with an implementation of the present invention;

FIG. 5 depicts a user interface displayed by the performance analysis system of FIG. 2;

FIGS. 6A-C depict a flow diagram illustrating the steps performed by the performance analysis system depicted in FIG. 2, in accordance with methods and systems consistent with a first embodiment of the present invention;

FIGS. 7A-F depict the user interface of FIG. 5 illustrating the process performed by the performance analysis system depicted in FIG. 2 using the flow diagram of FIGS. 6A-C;

FIGS. 8A-H depict a flow diagram illustrating the steps performed by the performance analysis system depicted in FIG. 2, in accordance with methods and systems consistent with a second embodiment of the present invention; and

FIGS. 9A-F depict the user interface of FIG. 5 illustrating the process performed by the performance analysis system depicted in FIG. 2 using the flow diagram of FIGS. 8A-H.

### DETAILED DESCRIPTION OF THE INVENTION

Reference will now be made in detail to an implementation consistent with the present invention as illustrated in the accompanying drawings. Wherever possible, the same reference numbers will be used throughout the drawings and the following description to refer to the same or like parts.

Overview

Methods, systems, and articles of manufacture consistent with the present invention utilize performance data collected during execution of an application program to illustrate graphically for the developer performance data associated with the program. The program is instrumented to generate the performance data during execution. Each program thread performs one or more operations, each operation reflecting a different state of the thread. The performance data may reflect an overall performance for each thread as well as a performance level for each state within a thread during execution. The developer can specify the type and extent of performance data to be collected. By providing a graphical display of the performance of all threads together, the developer can see where to make any appropriate adjustments to improve overall performance by better synchronizing operations among the threads.

A performance analysis database access language is used to instrument the program in a manner consistent with the principles of the present invention. Instrumentation can be done automatically using known techniques that add instructions to programs at specific locations within the programs, or manually by a developer. The instructions may specify collection of performance data from multiple system components, for example, performance data may be collected from both hardware and the operating system.

A four-dimensional display of performance data includes information on threads, times, states, and performance level. A performance analyzer also evaluates quantitative expressions corresponding to performance metrics specified by a developer, and displays the computed value.

Performance Analysis System

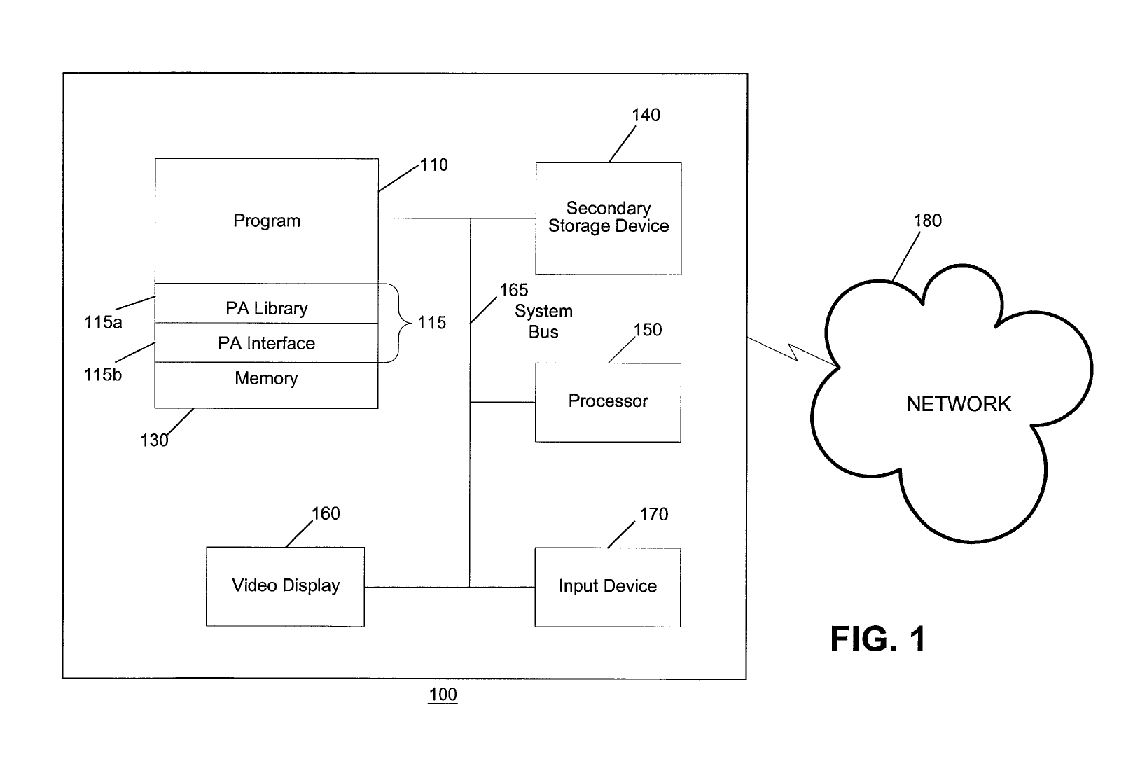

FIG. 1 depicts an exemplary data processing system 100 suitable for practicing methods and systems consistent with the present invention. Data processing system 100 includes a computer system 105 connected to a network 190, such as a Local Area Network, Wide Area Network, or the Internet.

Computer system 105 contains a main memory 130, a secondary storage device 140, a processor 150, an input device 170, and a video display 160. These internal components exchange information with one another via a system bus 165. The components are standard in most computer systems suitable for use with practicing methods and configuring systems consistent with the present invention. One such computer system is the SPARCstation from Sun Microsystems, Inc.

Although computer system 100 contains a single processor, it will be apparent to those skilled in the art that methods consistent with the present invention operate equally as well with a multi-processor environment.

Memory 130 includes a program 110 and a performance analyzer 115. Program 110 is a multi-threaded program. For purposes of facilitating performance analysis of program 110 in a manner consistent with the principles of the present invention, the program is instrumented with appropriate instructions of the developer's choosing to generate certain performance data.

Performance analyzer 115 is comprised of two components. The first component 115a is a library of functions to be performed in a manner specified by the instrumented program. The second component 115b is a developer interface that is used for two functions: (1) automatically instrumenting a program; and (2) viewing performance information collected when an instrumented program is executed.

As explained, instrumentation can be done automatically with the use of performance analyzer interface 115b. According to this approach, the developer simply specifies for the analyzer the type of performance data to be collected and the analyzer adds the appropriate commands from the performance analysis database access language to the program in the appropriate places. Techniques for automatic instrumentation in this manner are familiar to those skilled in the art. Alternatively, the developer may manually insert commands from the performance analysis database access language in the appropriate places in the program so that during execution specific performance data is recorded. The performance data generated during execution of program 110 is recorded in memory, for example, main memory 130.

Performance analyzer interface 115b permits developers to view performance information corresponding to the performance data recorded when program 110 is executed. As explained below, the developer may interact with the analyzer to alter the view to display performance information in various configurations to observe different aspects of the program's performance without having to repeatedly execute the program to collect information for each view, provided the program was properly instrumented at the outset. Each view may show (i) a complete measurement cycle for one or more threads; (ii) when each thread enters and leaves each state; and (iii) selected performance criteria corresponding to each state.

Although not shown in FIG. 1, like all computer systems, system 105 has an operating system that controls its operations, including the execution of program 110 by processor 150. Also, although aspects of one implementation consistent with the principles of the present invention are described herein with performance analyzer stored in main memory 120, one skilled in the art will appreciate that all or part of systems and methods consistent with the present invention may be stored on or read from other computer-readable media, such as secondary storage devices, like hard disks, floppy disks, and CD-ROM; a carrier wave received from the Internet; or other forms of ROM or RAM. Finally, although specific components of data processing system 100 have been described, one skilled in the art will appreciate that a data processing system suitable for use with the exemplary embodiment may contain additional or different components.

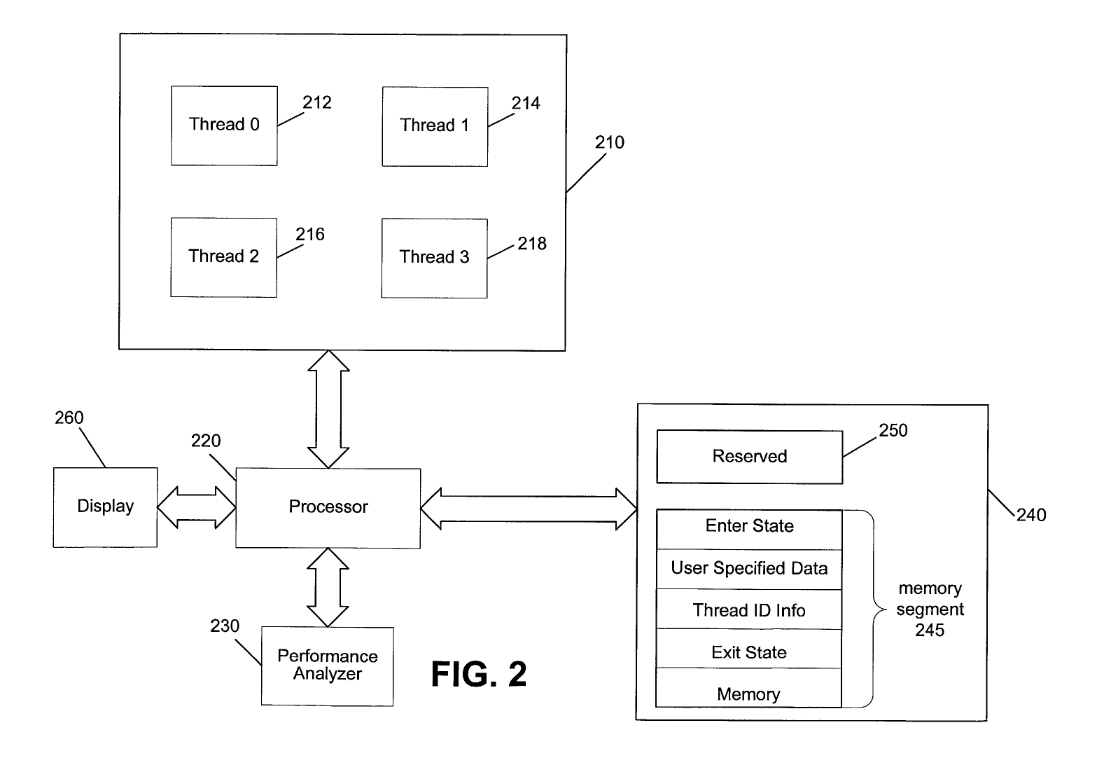

FIG. 2 depicts a block diagram of a performance analysis system consistent with the present invention. As shown, program 210 consists of multiple threads 212, 214, 216, and 218. Processor 220 executes threads 212, 214, 216, and 218 in parallel. Memory 240 represents a shared memory that may be accessed by all executing threads. A protocol for coordinating access to a shared memory is described in U.S. patent application Ser. No. 09/244,135, of Shaun Dennie, entitled “Protocol for Coordinating the Distribution of Shared Memory,” filed on Feb. 4, 1999 (Attorney Docket No. 06502-0207-00000), which is incorporated herein by reference. Although a single processor 220 is shown, multiple processors may be used to execute threads 212, 214, 216, and 218.

To facilitate parallel execution of multiple threads 212, 214, 216, and 218, an operating system partitions memory 240 into segments designated for operations associated with each thread and initializes the field of each segment. For example, memory segment 245 is comprised of enter and exit state identifiers, developer specified information, and thread identification information. An enter state identifier stores data corresponding to when, during execution, a thread enters a particular state. Similarly, an exit state identifier stores data corresponding to when, during execution of an application program, a thread leaves a particular state. Developer specified data represents the performance analysis data collected.

A reserved area of memory 250 is used to perform administrative memory management functions, such as, coordinating the distribution of shared memory to competing threads. The reserved area of memory 250 is also used for assigning identification information to threads using memory.

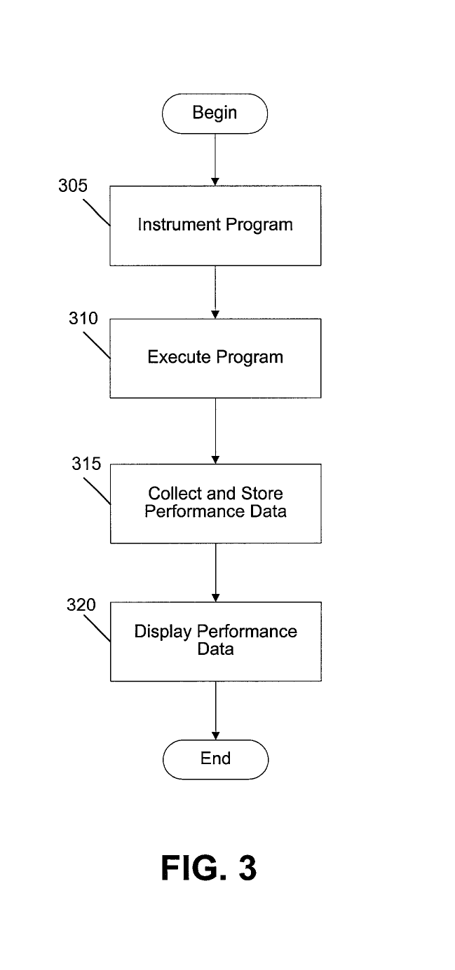

The flow chart of FIG. 3 provides additional details regarding the operation of a performance analysis system consistent with an implementation of the present invention. Instructions that generate performance data are inserted into a program (step 305). The instrumented program is executed and the performance data are generated (steps 310 and 315). In response to a request to view performance data, performance analyzer accesses and displays the performance data (step 320).

Performance analyzer is capable of displaying both the performance data and the related source code and assembly code, i.e., machine instructions, corresponding to the data. This allows a developer to relate performance data to both the source code and the assembly code that produced the data.

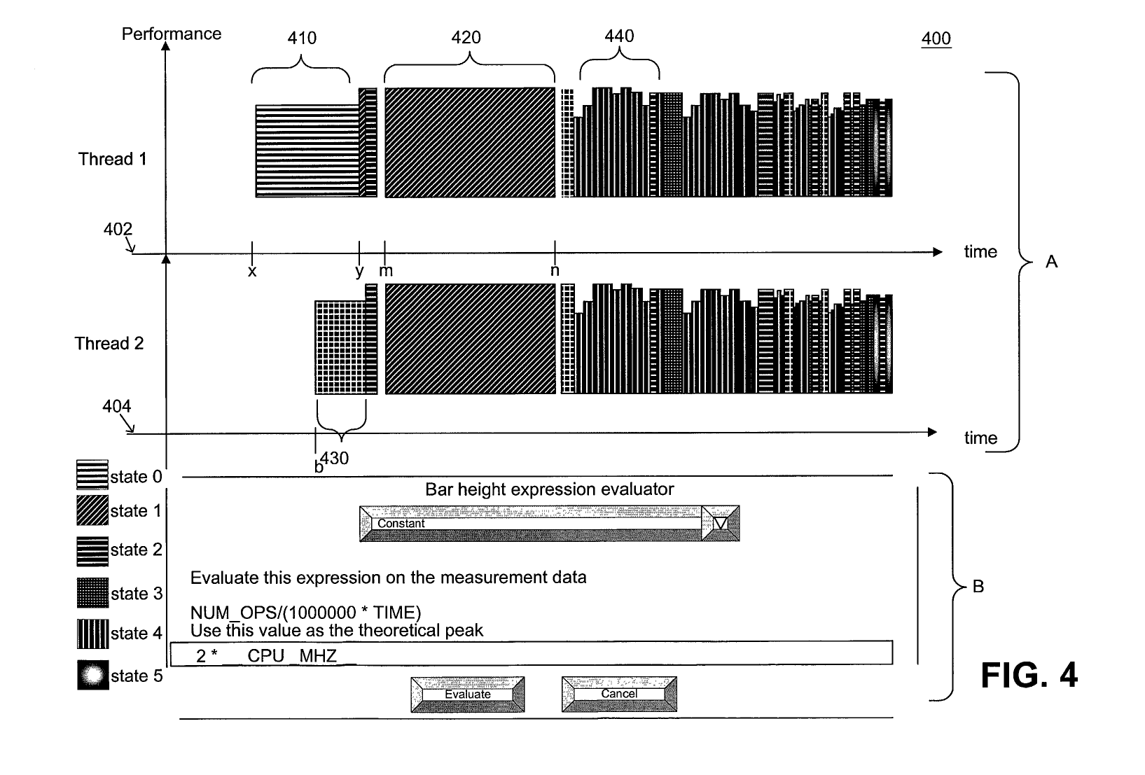

FIG. 4 shows a display 400 with two parts labeled A and B, respectively. The first part, labeled A, shows the performance characteristics of an application program in four dimensions: threads, time, states, and performance. Performance information for each thread is displayed horizontally using a bar graph-type format. Time is represented on the horizontal axis; performance is represented on the vertical axis.

Two threads, thread 1 and thread 2 in display 400, were executing concurrently. As shown, the threads began executing at different times. The horizontal axis for thread 1 is labeled 402. Thread 1 began executing at a point in time labeled “x” on the horizontal axis 402. The horizontal axis for thread 2 is labeled 404. Thread 2 began executing at time “b”. Each thread performed operations in multiple states, each state being represented by a different pattern. Thread 2 was idle at the beginning of the measuring period. One reason for this idle period may be that thread 2 was waiting for resources from thread 1. Based on this information, a developer can allocate operations of a thread among states such that performance will be improved, for example, by not executing concurrent operations that require use of the same system resources.

As shown, thread 1 entered state 410 at a point in time “x” on the horizontal axis 402 and left state 410 at time “y”, and entered state 420 at time “m” and left state 420 at time “n”. The horizontal distance between points “x” and “y” is shorter than the horizontal distance between points “m” and “n”. Therefore, thread 1 operated in state 420 longer than it operated in state 410. The vertical height of the bars shows a level of performance. The vertical height for state 410 is lower than the vertical height for state 420, showing that states 410 and 420 operated at different levels of performance. The change in vertical height as an executing thread transitions from one state to another corresponds to changes in performance level. This information may be used to identify the effect of transitioning between consecutive states on performance, and directs a developer to areas of the program for making changes to increase performance.

The bottom-half of the display, labeled B, illustrates an expression evaluation feature of the performance analyzer's interface. A developer specifies computational expressions related to a performance metric of a selected state(s). The performance analyzer computes the value of an expression for the performance data collected.

In the example shown, the developer has selected state 440. The expression on the first line, “NUM_OPS/ (100000* TIME)”, is an expression for computing the number (in millions) of floating point instructions per second (MFLOPS). The expression on the second line, “2*_CPU_MHZ” calculates a theoretical peak level of performance for a specified state. Performance analyzer may evaluate these two expressions in conjunction to provide quantitative information about a particular state. For example, by dividing MFLOPS by the theoretical peak performance level for state 440, performance analyzer calculates for the developer the percentage of theoretical peak represented by each operation in state 440.

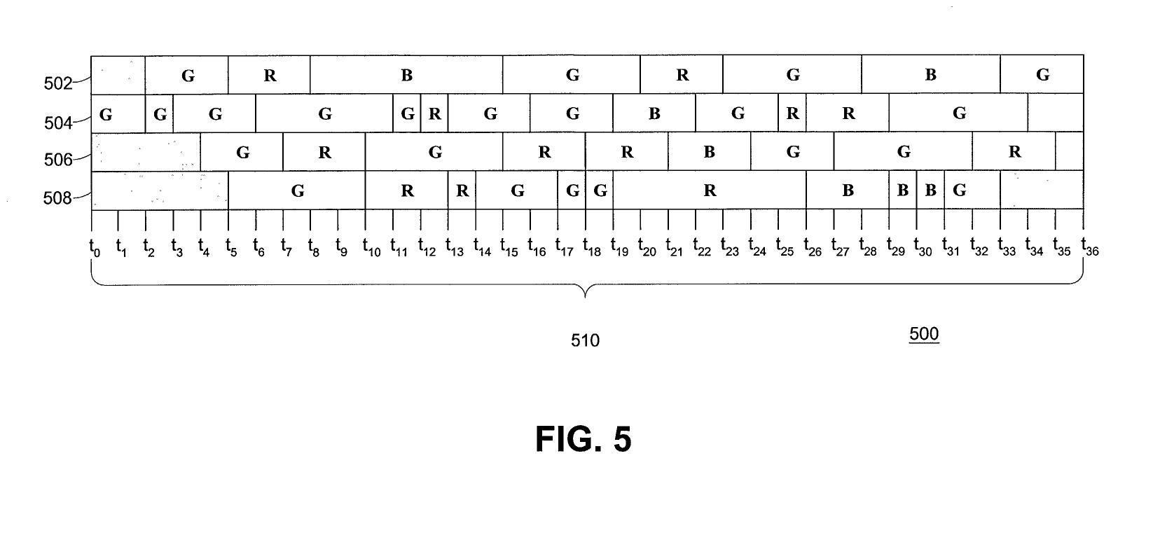

FIG. 5 depicts a second display 500 illustrating a second output of the performance analysis system. As shown in FIG. 5, the second display 500 includes information for four threads: Thread₁ 502, Thread₂ 504, Thread₃ 506, and Thread₄ 508. The information includes the time at which a new event occurs 510 and the state of each event. Three different states (G, R, and B) are illustrated in FIG. 5.

The performance data is generated by inserting a command in the program to record the state of the program and the time at the beginning of each state. Upon execution, a state identifier (s) and time stamp (t) are generated and stored in the secondary storage device 140 as an event, where each event consists of an ordered pair, (s, t). Each ordered pair represents an event that occurred during the execution of the code. The state identifier corresponds to the portion of code that began execution at the time identified by the time stamp. For example, the state identifier may correspond to the following portions of code: initialize, sort, stall, find, compute, read file, etc. The performance analyzer 115 displays, in sorted order, the amount of time that each thread or CPU spends in each of the states. For example, the first event of Thread₁ 502 is state G, which begins at time t₂. Thus, the ordered pair (G, t₂) represents the first event of Thread₁ 502. The second event of Thread₁ 502 is state R, which begins at time t₅. Thus, the ordered pair (R, t₅) represents the second event of Thread₁ 502. A table listing the ordered pairs for Thread₁ 502, Thread₂ 504, Thread₃ 506, and Thread₄ 508 of FIG. 5 is shown below:

| | Thread₁ | Thread₂ | Thread₃ | Thread₄ |
|---|---|---|---|---|
| Event 1 | (G, t₂) | (G, t₀) | (G, t₄) | (G, t₅) |
| Event 2 | (R, t₅) | (G, t₂) | (R, t₇) | (R, t₁₀) |
| Event 3 | (B, t₈) | (G, t₃) | (G, t₁₀) | (R, t₁₃) |
| Event 4 | (G, t₁₅) | (G, t₆) | (R, t₁₅) | (G, t₁₄) |
| Event 5 | (R, t₂₀) | (G, t₁₁) | (R, t₁₈) | (G, t₁₇) |
| Event 6 | (G, t₂₃) | (R, t₁₂) | (B, t₂₁) | (G, t₁₈) |
| Event 7 | (B, t₂₈) | (G, t₁₃) | (G, t₂₄) | (R, t₁₉) |
| Event 8 | (G, t₃₃) | (G, t₁₆) | (G, t₂₇) | (B, t₂₆) |
| Event 9 | (end, t₃₆) | (B, t₁₉) | (R, t₃₂) | (B, t₂₉) |
| Event 10 | | (G, t₂₂) | (end, t₃₅) | (B, t₃₀) |
| Event 11 | | (R, t₂₅) | | (G, t₃₁) |
| Event 12 | | (R, t₂₆) | | (end, t₃₃) |
| Event 13 | | (G, t₂₉) | | |
| Event 14 | | (end, t₃₄) | | |

The last event stored for each thread is the end of the thread.

Anchored States

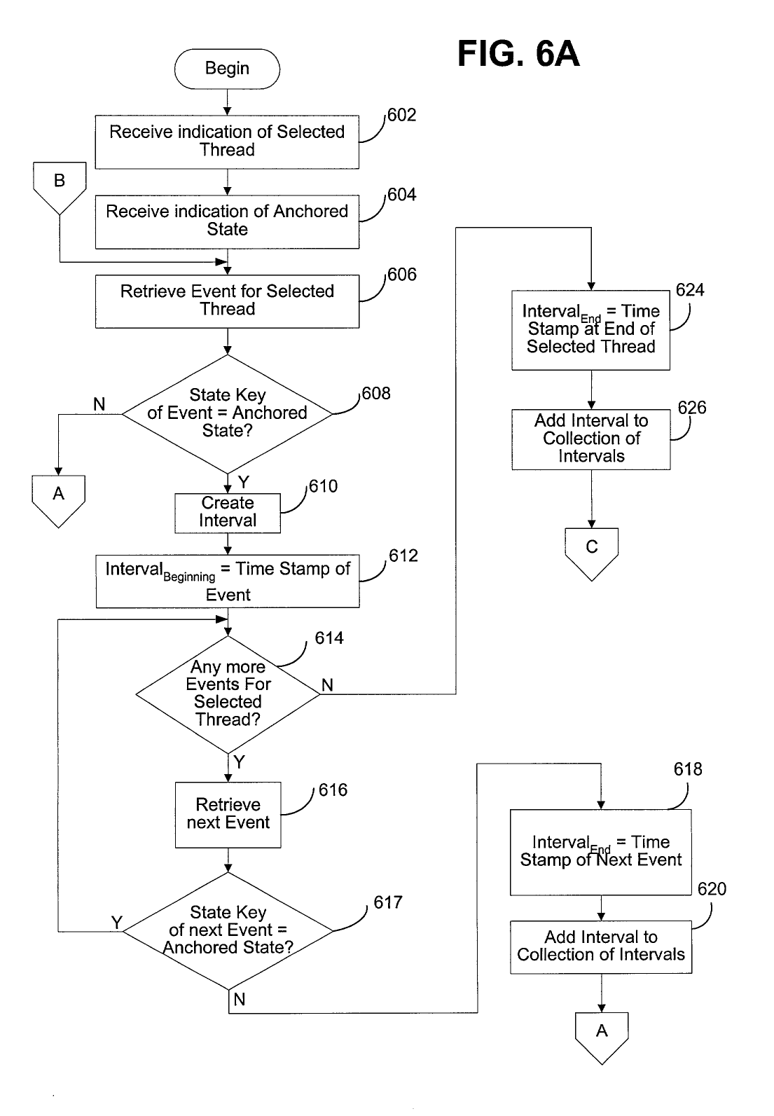

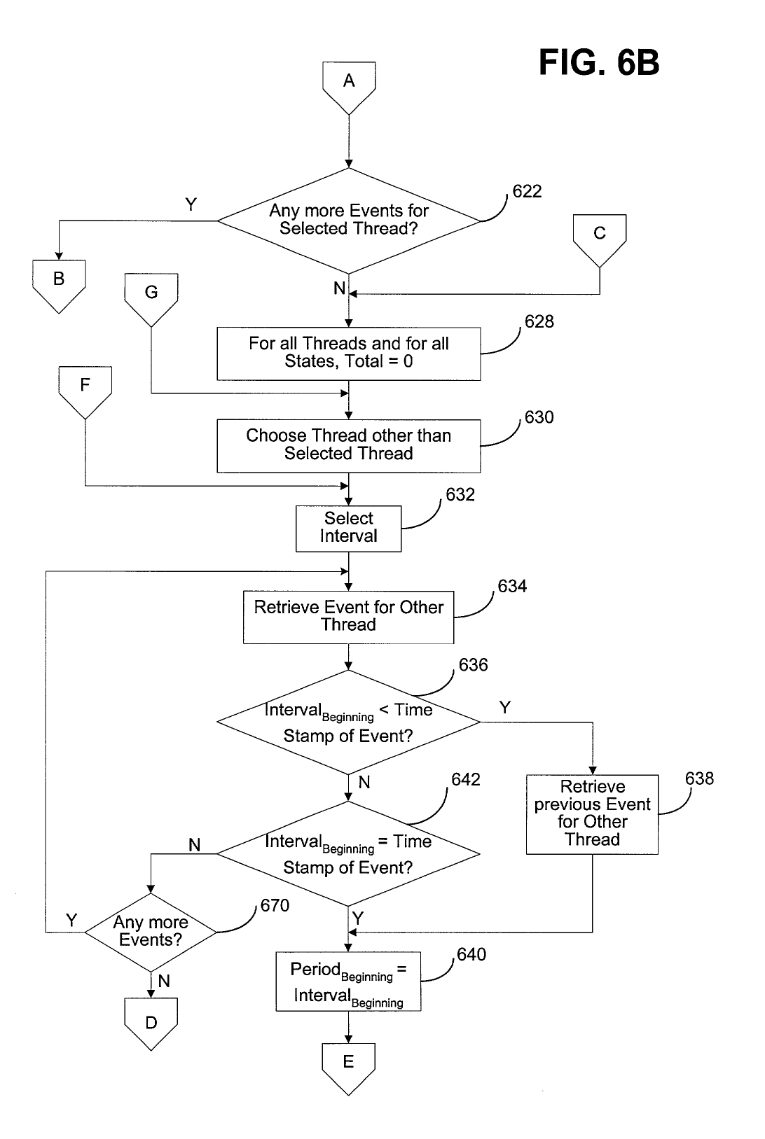

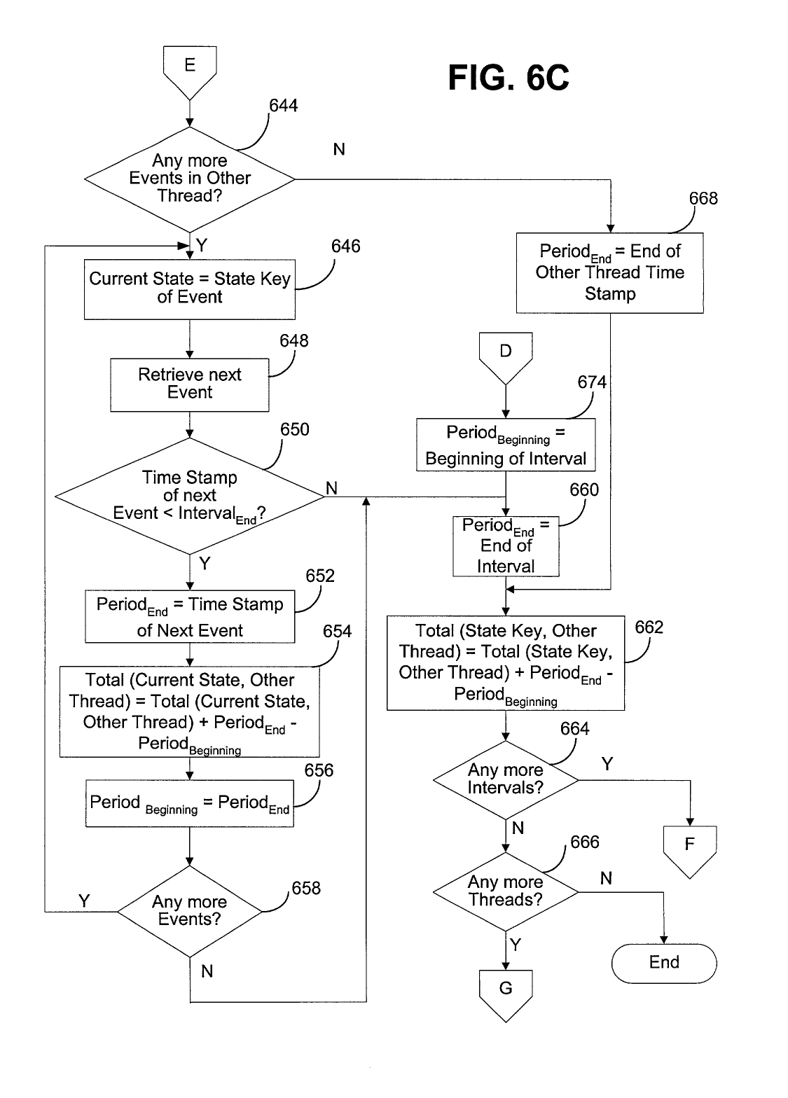

The performance analysis system, in accordance with methods and systems consistent with the present invention, may be used to select a state for one of the threads and determine the status of the other threads while the selected thread is in the selected state. The selected state is also referred to as an “anchored state.” FIGS. 6A-C depict a flow diagram illustrating the steps performed by the performance analysis system to analyze the performance of threads executing in a data processing system. In this embodiment, the performance analysis system may ultimately determine the percentage of time during the measuring period that one of the threads is in a specific state.

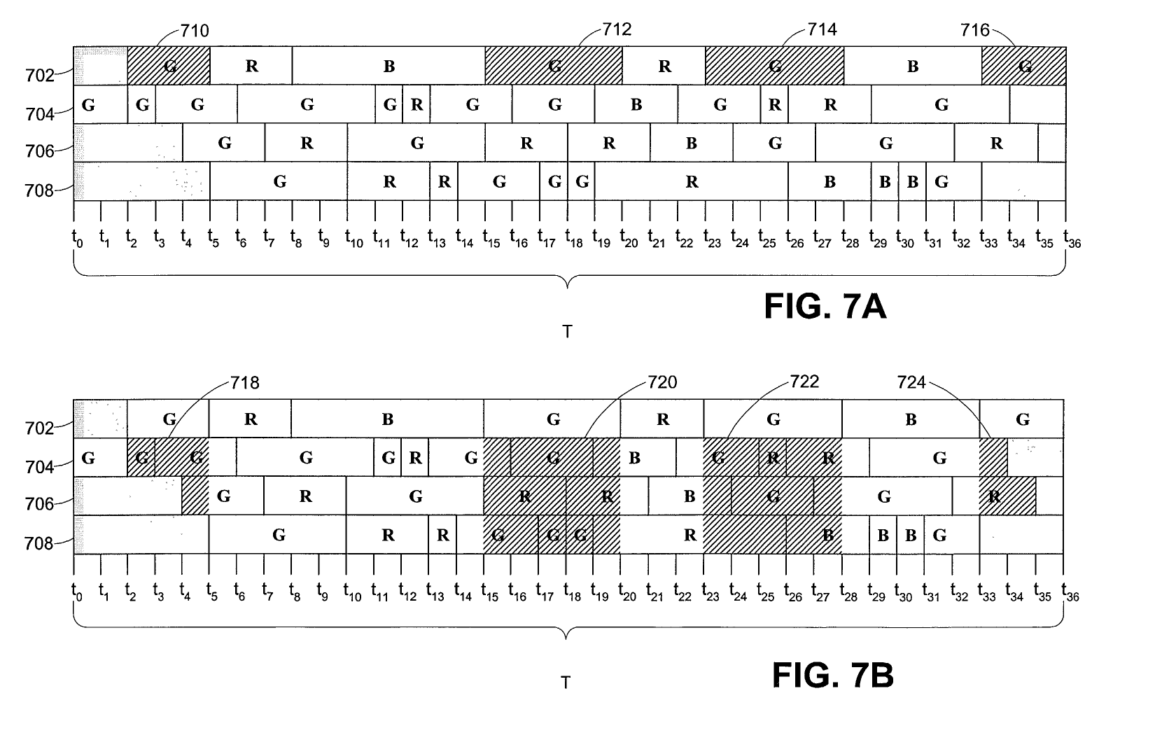

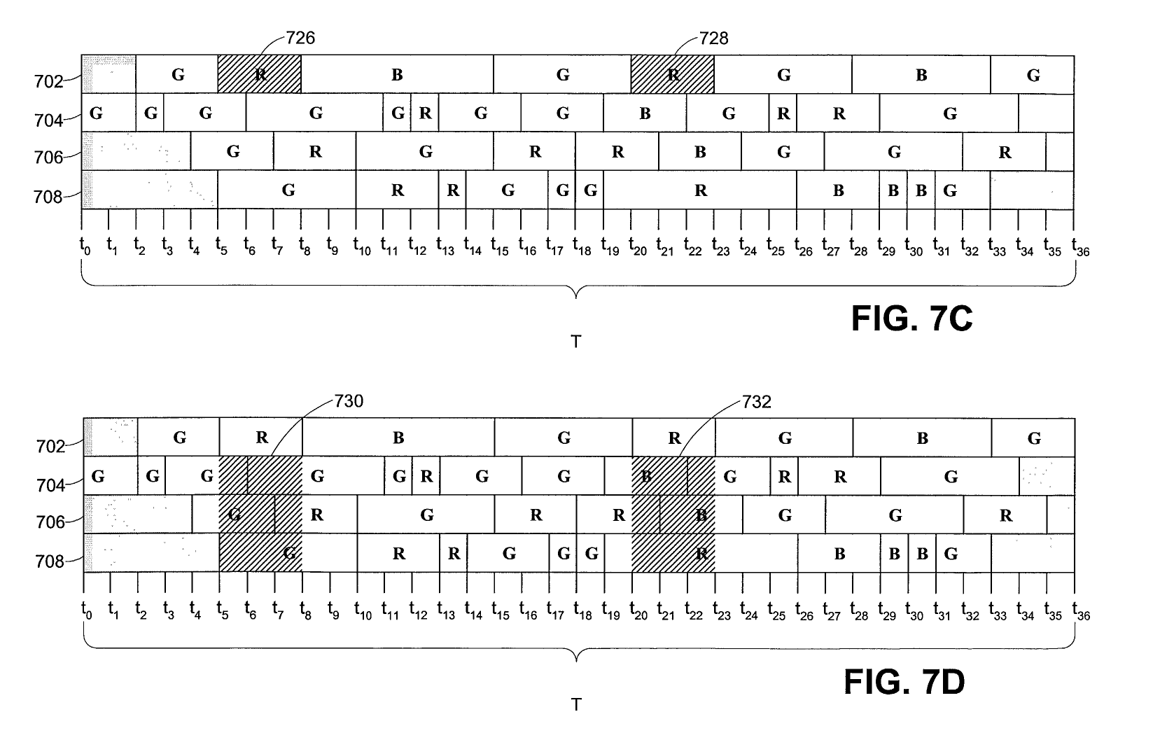

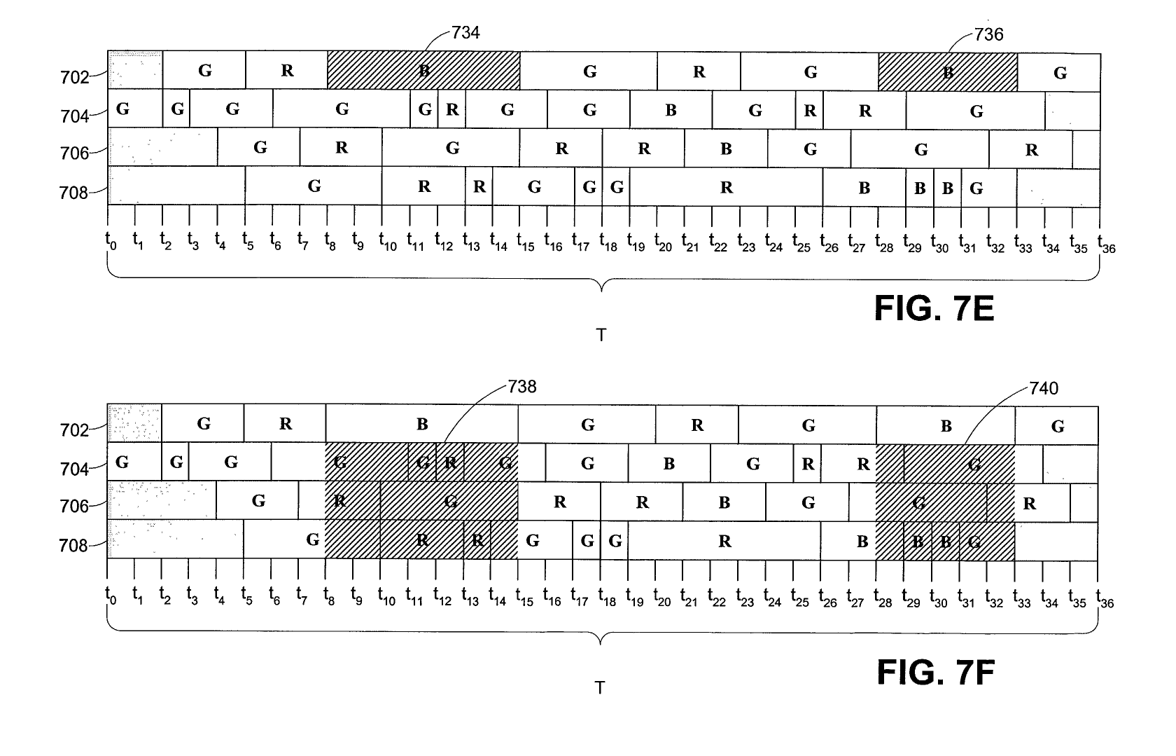

The process begins when the performance analyzer 115 receives an indication of the selected thread (step 602). The performance analyzer 115 also receives an indication of the anchored state (step 604). For example, using the display depicted in FIG. 5, a user may select Thread₁ 702 and set the anchored state to G. The events 710, 712, 714, and 716 that represent this selection are shown in FIG. 7A. The performance analyzer 115 then retrieves an event for the selected thread (step 606). Thereafter, the performance analyzer 115 determines whether the state key of the event is the anchored state (step 608). If the state key of the event is the anchored state, the performance analyzer 115 creates an interval (step 610). Each interval is an ordered pair (interval _{beginning}, interval_{end}), where interval_{beginning} represents the beginning of the interval and interval_{end} represents the end of the interval. The beginning of the interval is set to equal the time stamp of the event (step 612). For the example depicted in FIG. 7A, the performance analyzer 115 initially selects the first event, (G, t₂). Because the state key (G) of the event is the anchored state (G), the performance analyzer 115 creates an interval, and sets the beginning of the interval equal to the time stamp of the event (t₂), i.e., interval_{beginning}=t₂.

Next, the performance analyzer 115 determines whether there are any more events for the selected thread (step 614). If there are more events for the selected thread, the performance analyzer 115 retrieves the next event (step 616). The performance analyzer 115 then determines whether the state key of the next event is the anchored state (step 617). If the performance analyzer 115 determines that it is, the performance analyzer 115 returns to step 614 where it determines if there are any more events for the selected thread. If the performance analyzer 115 determines that the state key of the next event is not the anchored state, the next step performed by the performance analyzer 115 is to set the end of the interval equal to the time stamp of the next event (step 618). The interval is then added to a collection of intervals for the selected thread (step 620). In the example shown in FIG. 7A, the next event, (R, t₅), is retrieved. Because the state key of the next event is not the anchored state, the end of the interval is assigned the time stamp of the event, i.e., interval_{end}=t₅. Thus, the first interval for Thread₁ 702 is [t₂, t₅] when the anchored state is G. The performance analyzer 115 determines whether there are any more events for the selected thread (step 622, FIG. 6B). If there are more events, the process returns to step 606, and the performance analyzer 115 retrieves another event for the selected thread.

If, at step 614, there are no more events for the selected thread, the end of the interval is set to the time stamp at the end of the selected thread (step 624). The interval is then added to the collection of intervals (step 626). Because there are no more events for the selected thread, all intervals for the selected thread have been added to the collection of intervals. The same is true at step 622 if the performance analyzer 115 determines that there are no more events for the selected thread. Returning to the example of FIG. 7A, when the selected thread is Thread₁ 702 and the anchored state is G, the collection of intervals includes the following intervals: [t₂, t₅], [t₁₅, t₂₀], [t₂₃, t₂₈], and [t₃₃, t₃₆].

After all intervals are collected, the performance analyzer 115 is ready to calculate the total amount of time the other threads are in different states during the intervals. The events occurring in the other threads while the selected thread is in the anchored state is shown by the shaded regions 718, 720, 722, and 724 in FIG. 7B. The performance analyzer 115 begins by setting the totals for all threads and all states to zero (step 628). These totals represent the amount of time each thread is in each state. The performance analyzer 115 then selects one of the other threads, i.e., it selects a thread that is not the selected thread (step 630). For example, in FIG. 7A, the selected thread is Thread₁ 702. Thus, the other thread may be Thread₂ 704, Thread₃ 706, or Thread₄ 708. The performance analyzer 115 also selects an interval from the collection of intervals (step 632). The next step performed by the performance analyzer 115 is to retrieve an event for the other thread (step 634). Next, the performance analyzer 115 determines whether the beginning of the interval is less than the time stamp of the event for the other thread (step 636). If the beginning of the interval is less than the time stamp, then the interval began before the current event. Thus, the performance analyzer 115 retrieves the previous event for the other thread to determine the event at the start of the interval (step 638). In other words, the first event selected from the other thread is selected based on the beginning time of the interval. The performance analyzer 115 then sets the beginning of the time period (time period_{beginning}) to the beginning of the interval (interval_{beginning}) (step 640). For example, the interval for event 712 is [t₁₅, t₂₀]. Assuming that the performance analyzer 115 is analyzing the eighth event on Thread₂ 704, the current event for Thread₂ 704 is (G, t₁₆). The beginning of the interval (t₁₅) is less than the time stamp of the event (t₁₆). Thus, the performance analyzer 115 retrieves the previous data thread for Thread₂ 704, and sets the beginning of the time period to the beginning of the interval, i.e., period_{beginning}−t₁₅.

If at step 636 the beginning of the interval is not less than the time stamp of the event, the performance analyzer 115 determines whether the beginning of the interval is equal to the time stamp of the event (step 642). If they are equal, the process continues at step 640. Thus, for event 710, the interval is [t₂, t₅]. If the performance analyzer 115 is analyzing the second event for Thread₂ 704, the beginning of the interval (t₂) is equal to the time stamp of the event (t₂). In this case, the performance analyzer 115 sets the beginning of the time period equal to the beginning of the interval, i.e., period_{beginning}=t₂.

The performance analyzer 115 then determines whether there are any more events in the other thread (step 644, FIG. 6C). If there are more events, the performance analyzer 115 stores the state key of the event in the current state (step 646). The performance analyzer 115 then retrieves the next event (step 648). The performance analyzer 115 determines whether the time stamp of the next event is less than the end of the interval (step 650). If the time stamp of the next event is less than the end of the interval, then the end of the time period (period_{end}) is set to equal the time stamp of the next event (step 652). Returning to the example shown in FIGS. 7A and 7B above, if the performance analyzer 115 is analyzing the second interval [t₁₅, t₂₀] and the eighth event (G, t₁₆) in Thread₂ 704, because the beginning of the interval t₁₅ is less than the time stamp of the event t₁₆, the performance analyzer 115 retrieves the previous event for Thread₂ (G, t₁₃) and sets the beginning of the period to the beginning of the interval, i.e., period_{beginning}=t₁₅. The performance analyzer 115 then sets the current state to the state key of the event, G, and retrieves the next event (G, t₁₆). Because the time stamp of the next event t₁₆ is less than the end of the interval t₂₀, the end of the time period is set to equal the time stamp of the next event, i.e., period_{end}=t₁₆.

The time period (i.e., period_{end}−period_{beginning}) is then added to the total for the current state and the other thread (step 654). The next step performed by the performance analyzer 115 is to set the beginning of the time period equal to the end of the time period (step 656). Next, the performance analyzer 115 determines whether there are any more events (step 658). If there are more events, the process continues at step 646. If there are no more events, the performance analyzer 115 sets the end of the time period equal to the end of the interval (step 660). The performance analyzer 115 also performs this step if it determines that the time stamp of the next event was not less than the end of the interval at step 650, i.e., if the event ended after the end of the interval. The time period is then added to the total for the current state and the other thread (step 662). Returning to the example above, after setting period_{beginning} to t₁₆, the performance analyzer 115 performs the following calculations:

Total(G, Thread₂)=Total(G, Thread₂)+t₁₆−t₁₅.

period_{beginning}=period_{end}=t₁₆.

Because there are more events, the performance analyzer 115 sets the current state to G and retrieves the next event (B, t₁₉). The time stamp of the next event t₁₉ is less than the end of the interval t₂₀. Thus, the performance analyzer 115 performs the following calculations:

period_{end}=t₁₉.

Total(G, Thread₂)=Total(G, Thread₂)+t₁₉−t₁₆.

period_{beginning}=period_{end}=t₁₉.

Because there are more events, the performance analyzer 115 sets the current state to B and retrieves the next event (G, t₂₂). The time stamp of the next event t₂₂ is greater than the end of the interval t₂₀. Thus, the performance analyzer 115 sets the end of the period equal to the end of the interval, and adjusts the Total for the state key and Thread₂. Thus, period_{end}=t₂₀, and Total(B, Thread₂)=Total(B, Thread₂)+t₂₀−t₁₉.

The next step performed by the performance analyzer 115 is to determine whether there are any more intervals (step 664). If there are more intervals, the process continues at step 632. If there are no more intervals, the performance analyzer 115 determines whether there are any more threads (step 666). If there are more threads, the process continues at step 630. Otherwise, the process ends.

If, at step 644, the performance analyzer 115 determines that there are no more events in the other thread, the end of the time period is set to equal the time stamp for the end of the other thread (step 668), and the process continues at step 662. If, at step 642, the beginning of the interval is not equal to the time stamp of the event, the performance analyzer 115 determines whether there are any more events for the other thread (step 670). If there are more events, the process continues at step 634. Otherwise, the performance analyzer 115 sets the beginning of the time period to equal the beginning of the interval (step 674), and the process continues at step 660.

If the anchored state for Thread₁ is R, as shown in FIG. 7C, the portions 730 and 732 of the events for the other threads which fall within the time intervals [t₅, t₈] and [t₂₀, t₂₃] for events 726 and 728, respectively, are shown in FIG. 7D. Similarly, if the anchored state for Thread₁ is B, as shown in FIG. 7E, the portions 738 and 740 of the events for the other threads which fall within the time intervals [t₈, t₁₅] and [t₂₈, t₃₃] for events 734 and 736, respectively, are shown in FIG. 7F. If the performance analyzer 115 were to perform the process depicted in FIGS. 6A-6C on the threads depicted in FIG. 5, it would determine the following totals, i.e., the amount of time each thread is in each state while the selected thread is in the anchored state, if G were the anchored state in Thread₁, as depicted in FIGS. 7A and 7B:

| State | Total(Thread₂) | Total(Thread₃) | Total(Thread₄) |
|---|---|---|---|
| G | t₃ − t₂ + t₅ − t₃ + t₁₆ − | t₅ − t₄ + t₂₇ − | t₁₇ − t₁₅ + t₁₈ − |
| | t₁₅ + t₁₉ − t₁₆ +t₂₅ − t₂₃ + | t₂₄ + t₂₈ − t₂₇ | t₁₇ + t₁₉ − t₁₈ |
| | t₃₄ − t₃₃ | | |
| R | t₂₆ − t₂₅ + t₂₈ − t₂₆ | t₁₈ − t₁₅ + t₂₀ − | t₂₀ − t₁₉ + t₂₆ − |
| | | t₁₈ + t₃₅ − t₃₃ | t₂₃ |
| B | t₂₀ − t₁₉ | t₂₄ − t₂₃ | t₂₈ − t₂₆ |

If R were the anchored state in Thread₁, as depicted in FIGS. 7C and 7D, the totals would be as follows:

| State | Total(Thread₂) | Total(Thread₃) | Total(Thread₄) |
|---|---|---|---|
| G | t₆ − t₅ + t₈ − t₆ + t₂₃ − t₂₂ | t₇ − t₅ | t₈ − t₅ |
| R | | t₈ − t₇ + t₂₁ − t₂₀ | t₂₃ − t₂₀ |
| B | t₂₂ − t₂₀ | t₂₃ − t₂₁ | |

If B were the anchored state in Thread₁, as depicted in FIGS. 7E and 7F, the totals would be as follows:

| State | Total(Thread₂) | Total(Thread₃) | Total(Thread₄) |
|---|---|---|---|
| G | t₁₁ − t₈ + t₁₂ − t₁₁ + t₁₅ − | t₁₅ − t₁₀ + t₃₂ − | t₁₀ − t₈ + t₁₅ − |
| | t₁₃ + t₃₃ − t₂₉ | t₂₈ | t₁₄ + t₃₃ − t₃₁ |
| R | t₁₃ − t₁₂ + t₂₉ − t₂₈ | t₁₀ − t₈ + t₃₃ − | t₁₃ − t₁₀ + t₁₄ − |
| | | t₃₂ | t₁₃ |
| B | | | t₂₉ − t₂₈ + t₃₀ − |
| | | | t₂₉ + t₃₁ − t₃₀ |

To determine the percentage of time each of the other threads is in a particular state while the selected thread is in the anchored state, these totals are divided by the sum of the intervals. For example, to determine the percentage of time Thread₂ is in state R while Thread₁ is anchored to state B, Total(Thread₂, R) is divided by the sum of the intervals. Thus,

$$Percentage ( {Thread}_{2} , R ) = \frac{{t}_{13} - {t}_{12} + {t}_{29} - {t}_{28}}{{t}_{15} - {t}_{8} + {t}_{33} - {t}_{28}}$$

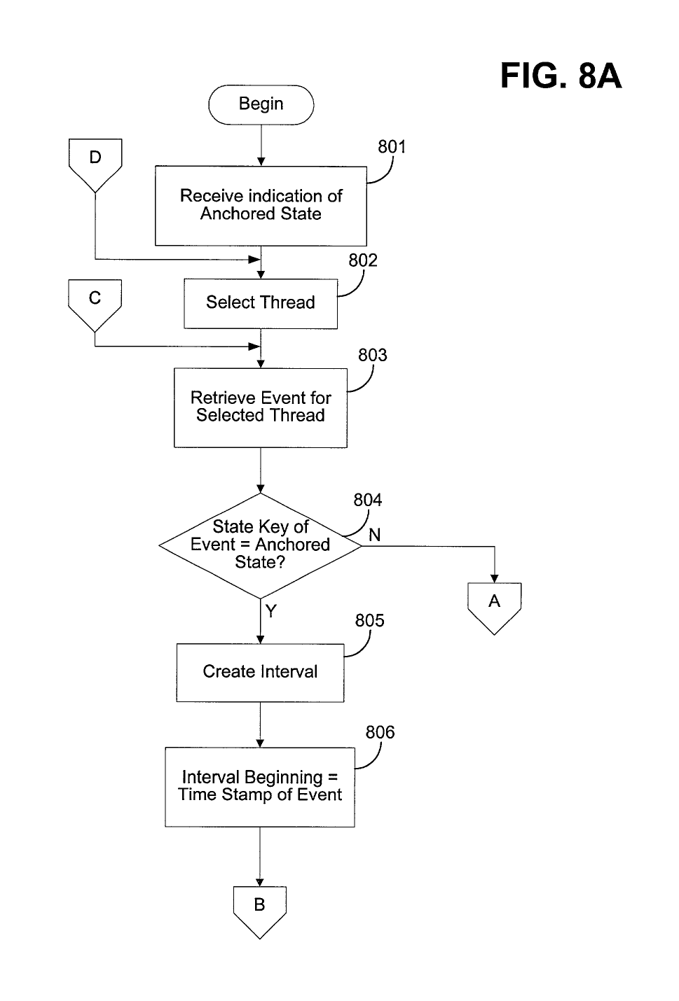

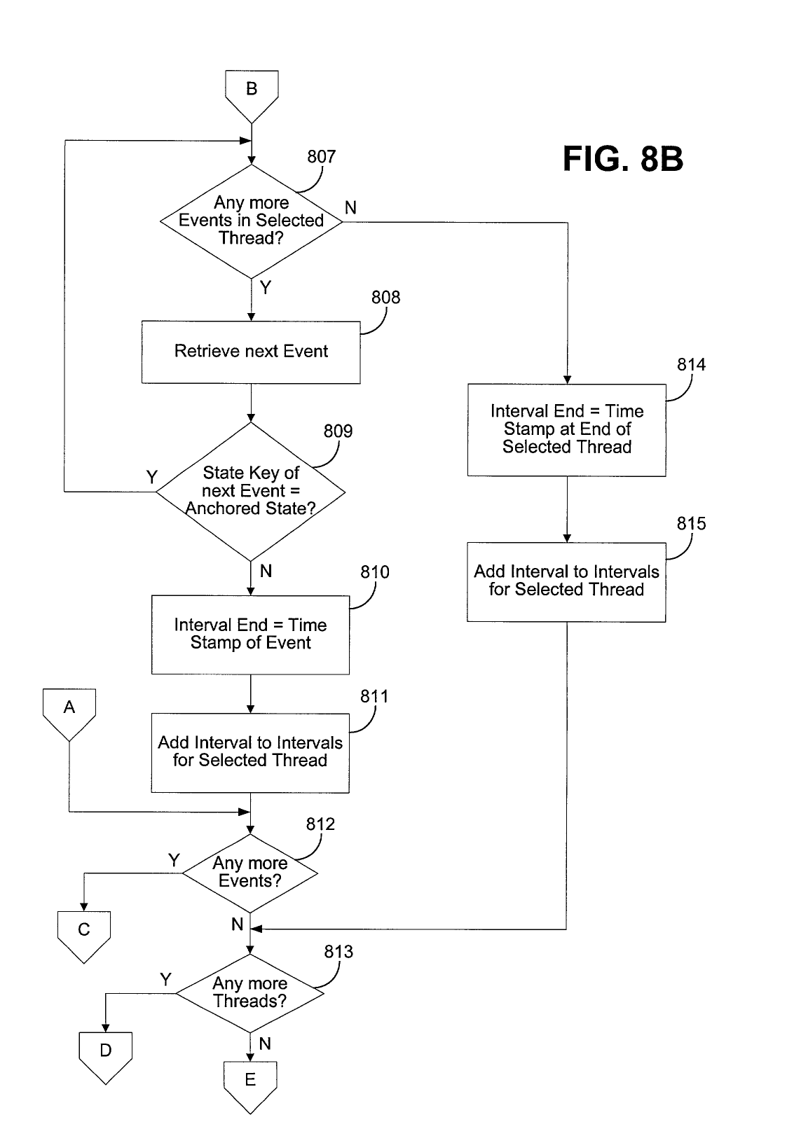

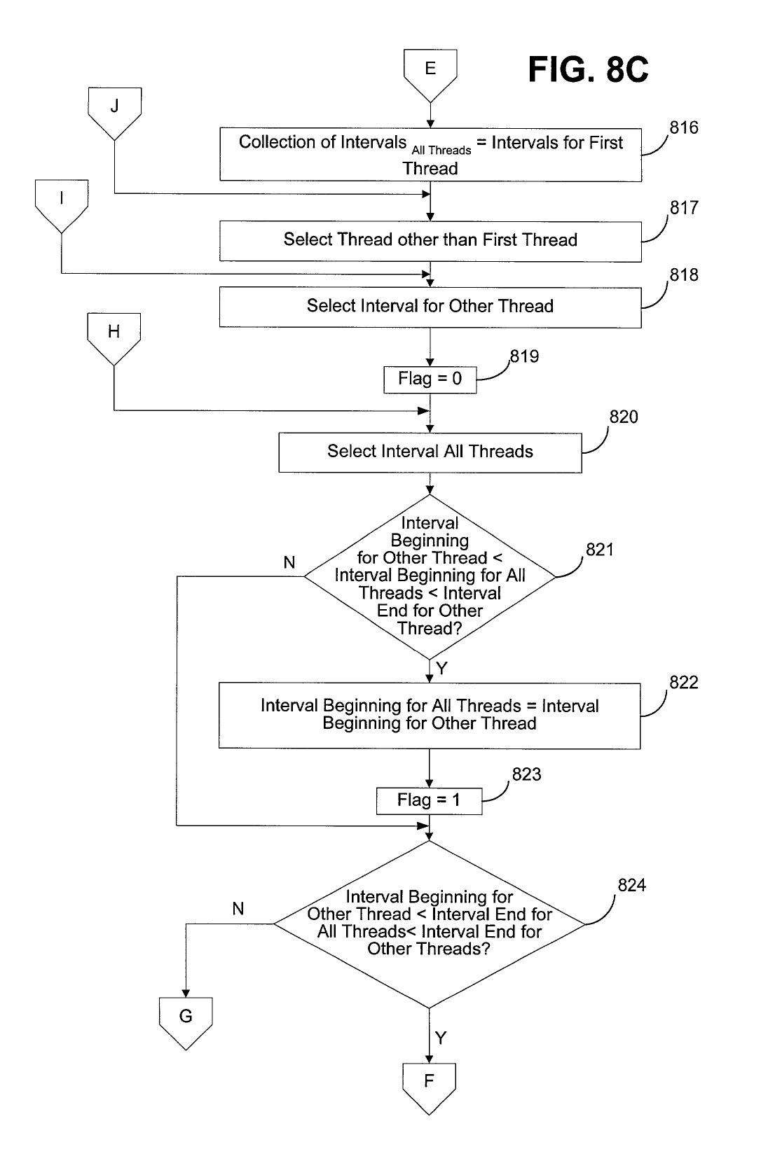

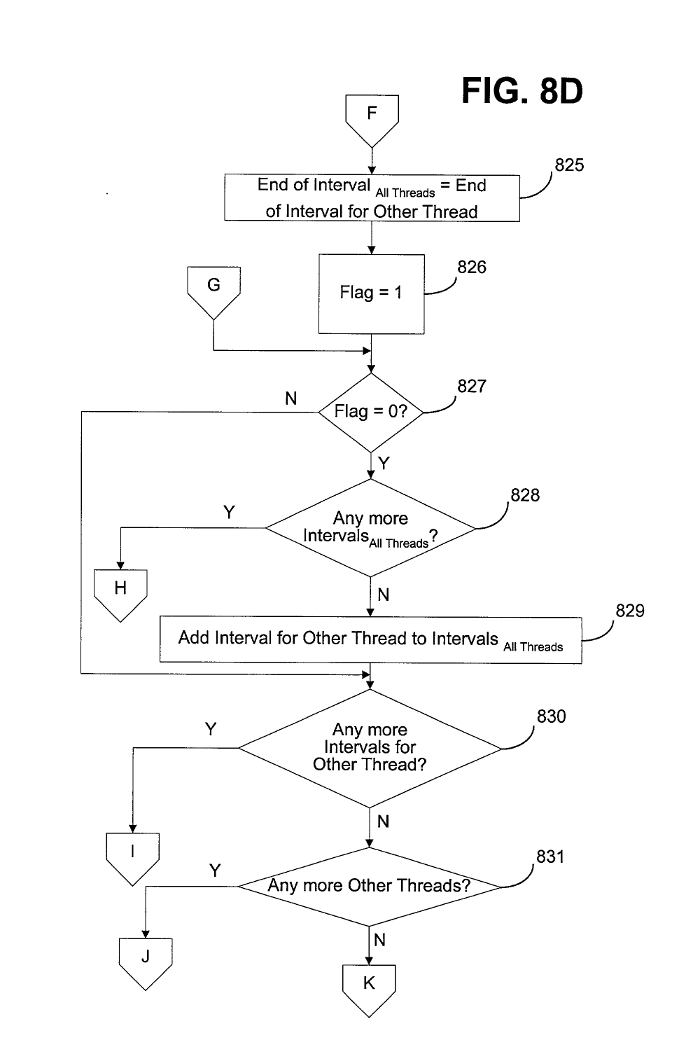

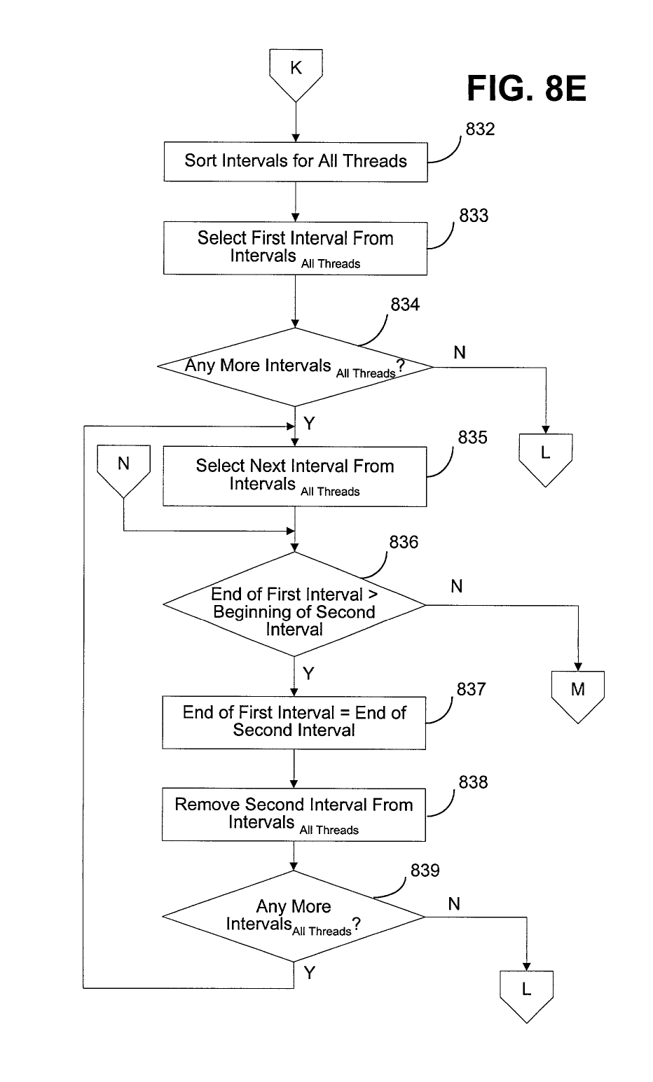

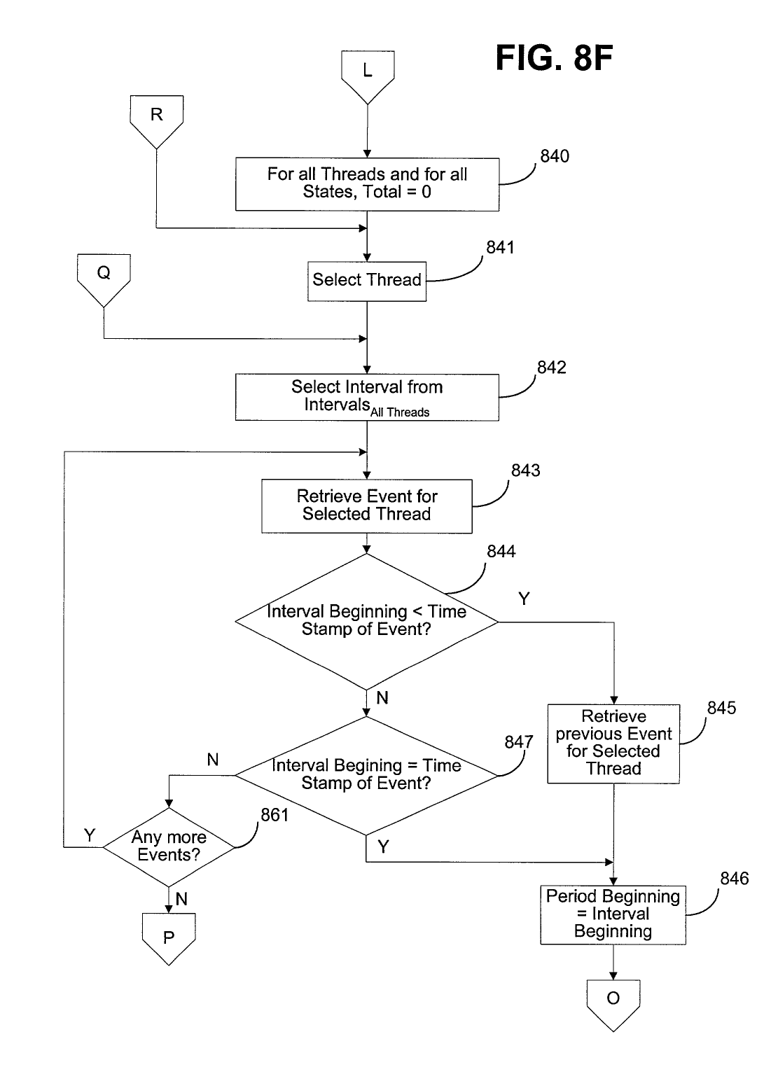

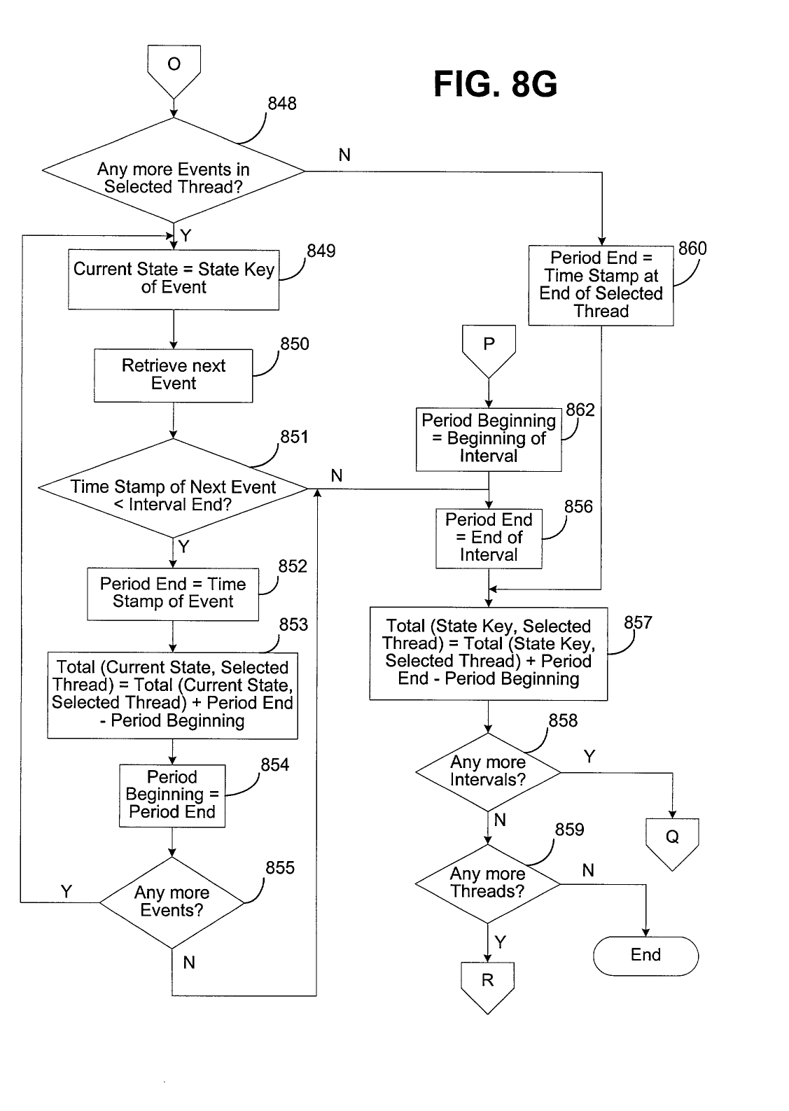

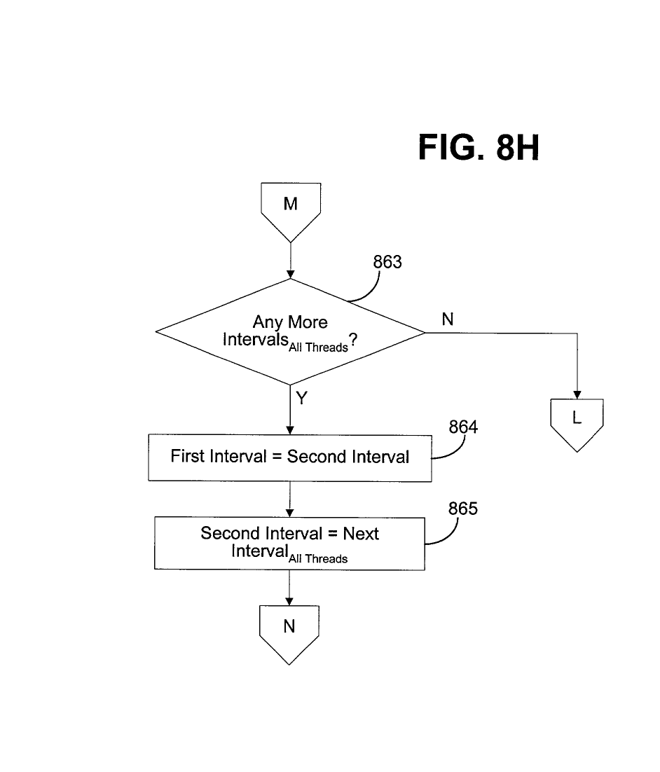

FIGS. 8A-H depict a flow diagram illustrating the steps performed by the performance analysis system in a second embodiment to analyze the performance of threads executing in a data processing system. In this second embodiment, the performance analysis system determines the status of all threads while any thread is in the anchored state. Thus, the intervals during which any thread is in the anchored state must be determined.

The performance analyzer 115 initially receives an indication of the anchored state (step 801). The performance analyzer 115 also selects a thread (step 802). The next step performed by the performance analyzer 115 is to retrieve an event for the selected thread (step 803). Next, the performance analyzer 115 determines whether the state key of the event is the anchored state (step 804). If the state key of the event is the anchored state, the performance analyzer 115 creates an interval (step 805). The performance analyzer 115 sets the beginning of the interval equal to the time stamp of the event (step 806). The performance analyzer 115 then determines whether there are any more events for the selected thread (step 807. FIG. 8B). If there are more events, the performance analyzer 115 retrieves the next event (step 808). The performance analyzer 115 then determines whether the state key of the next event is the anchored state (step 809). If the performance analyzer determines that it is, then the performance analyzer 115 returns to step 807 where it determines whether there are any more events for the selected thread. If the performance analyzer 115 determines that the state key of the next event is not the anchored state, then the next step performed by the performance analyzer 115 is to set the end of the interval equal to the time stamp of the event (step 810). The interval is then added to the intervals for the selected thread (step 811). The performance analyzer 115 then determines whether there are any more events (step 812). If there are more events, the process continues at step 803 with the next event. If there are no more events, the performance analyzer 115 determines whether there are any more threads (step 813). If there are more threads, the process returns to step 802 with the next thread.

If, at step 807, there are no more events for the selected thread, the performance analyzer 115 sets the end of the interval equal to the time stamp at the end of the selected thread (step 814). The interval is then added to the set of intervals for the selected thread (step 815). Next, the performance analyzer 115 continues at step 813 by determining whether there are any more threads. For example, assuming that the developer chooses G as the anchored state and that the performance analyzer 115 initially selects Thread₂, the first event retrieved is (G, t₀). Because the state key of the event is the same as the anchored state, the performance analyzer 115 creates an interval, and sets the beginning of the interval equal to the time stamp of the event, i.e., interval_{beginning}=t₀. Because there are more events, the performance analyzer 115 retrieves the next event (G, t₂). Because the state key of his event is also the anchored state, and because there are still more events, the performance analyzer 115 retrieves the next event, (G, t₃). After determining that this event is also the anchored state and that there are more events, the performance analyzer 115 retrieves the next event, (G, t₆). This process continues until the performance analyzer 115 reaches an event that is not the anchored state, i.e., until it reaches (R, t₁₂). The performance analyzer 115 sets the end of the interval equal to the time stamp of the data stamp, i.e., interval_{end}=t₁₂, and the interval formed, [t₀, t₁₂], is added to the set of intervals for Thread₂. The performance analyzer 115 then continues with the next event (G, t₁₃). This process continues until the performance analyzer 115 creates the following intervals for the corresponding threads:

| | | | | |
|---|---|---|---|---|
| Thread₁ | [t₂, t₅] | [t₁₅, t₂₀] | [t₂₃, t₂₈] | [t₃₃, t₃₆] |
| Thread₂ | [t₀, t₁₂] | [t₁₃, t₁₉] | [t₂₂, t₂₅] | [t₂₉, t₃₄] |
| Thread₃ | [t₄, t₇] | [t₁₀, t₁₅] | [t₂₄, t₃₂] | |
| Thread₄ | [t₅, t₁₀] | [t₁₄, t₁₉] | [t₃₁, t₃₃] | |

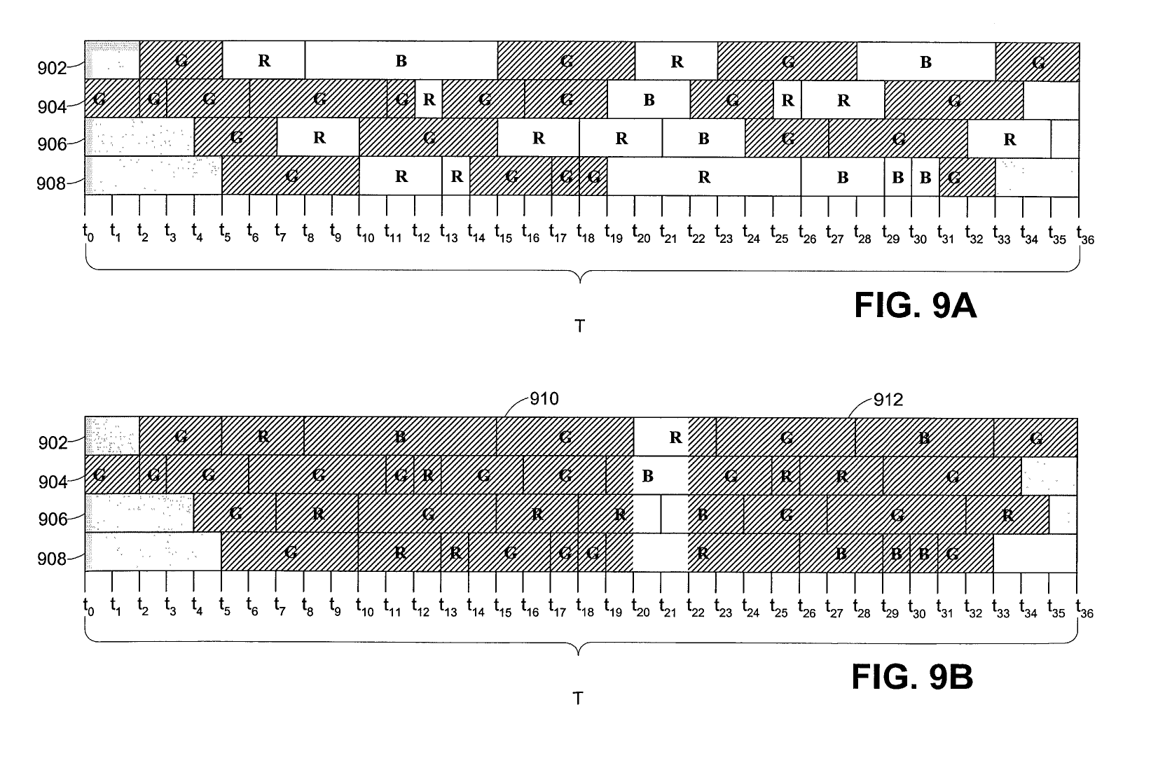

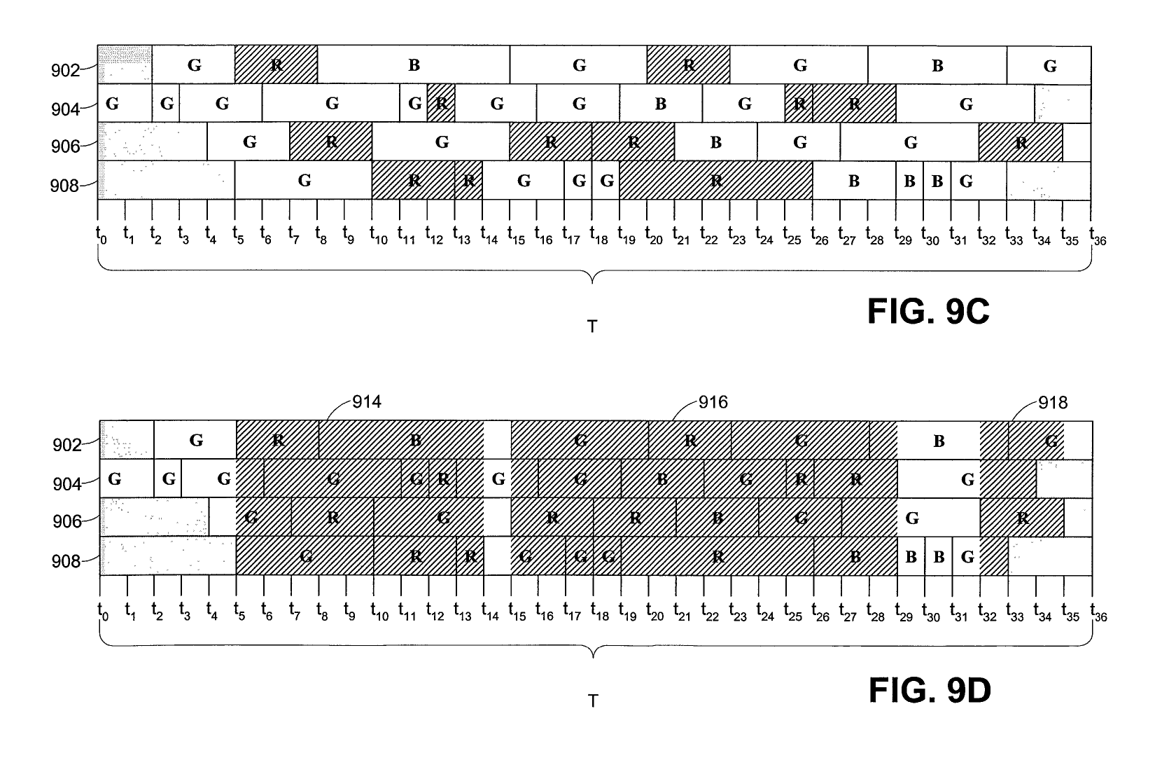

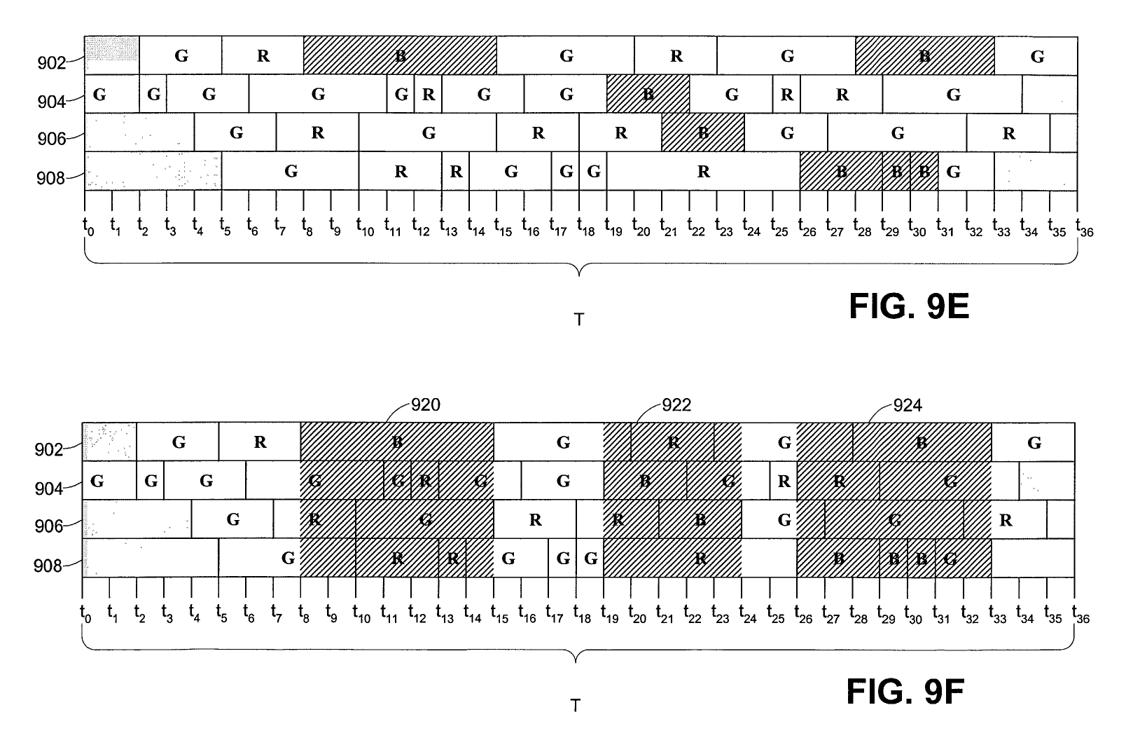

The events having an anchored state of G are shaded in the threads depicted in FIG. 9A. At this point, the performance analyzer 115 has determined when any thread is in the anchored state. Because there are overlaps in the intervals, e.g., the first interval for Thread₁ overlaps with the first intervals for Thread₂ and Thread₃, the performance analyzer 115 must now determine a collection of intervals with no overlaps. This portion of the process is depicted in FIGS. 8C-E.

The performance analyzer 115 initializes the collection of intervals for all threads (intervals_{all threads}) to the intervals for the first thread (step 816, FIG. 8C). Although the process initializes the intervals for all threads to the intervals for the first thread, any of the available threads may be chosen as the initial thread. The performance analyzer 115 then selects another thread, i.e., a thread that is different from the first thread (step 817). The next step performed by the performance analyzer 115 is to select an interval for the other thread (step 818). Then, the performance analyzer 115 initializes a flag, i.e., flag=0 (step 819). The flag identifies when there is an overlap of intervals. Thus, flag=1 when the performance analyzer 115 determines there is an overlap between intervals.

The performance analyzer 115 then selects the first interval for all threads (step 820). Next, the performance analyzer 115 determines whether the beginning of the interval for all threads falls within the interval for the other thread (step 821). If the beginning of the interval for all threads falls within the interval for the other thread, the beginning of the interval for the other thread becomes the beginning of the interval for all threads (step 822). Because there was an overlap between the intervals, the flag is set to equal 1 (step 823). Otherwise, the performance analyzer 115 determines whether the end of the interval for all threads falls within the interval for the other thread (step 824). If the end of the interval for all threads falls within the interval for the other thread, the end of the interval for the other thread becomes the end of the interval for all threads (step 825, FIG. 8D). Again, because the performance analyzer 115 found an overlap between intervals, the flag is set to equal 1 (step 826). The performance analyzer 115 then determines whether the flag is zero, i.e., no overlap was found (step 827). If no overlap was found, the performance analyzer 115 determines whether there are any more intervals for all threads (step 828). If there are more intervals for all threads, the process continues at step 820 with the next interval for all threads. If there are no more intervals for all threads, the performance analyzer 115 adds the interval for the other thread to the intervals for all threads (step 829). The performance analyzer 115 then determines whether there are any more intervals for the other thread (step 830). This step is also performed if the flag is found to not equal zero at step 827. If there are more intervals for other threads, the process continues at step 818 with the next interval for other thread. Otherwise, the performance analyzer 115 determines whether there are any more other threads (step 831). If there are any more other threads, the process continues with the next thread at step 817.

If there are no more threads, the performance analyzer 115 sorts the intervals for all threads (step 832, FIG. 8E). The performance analyzer 115 selects the first interval from the intervals for all threads (step 833). Next, the performance analyzer 115 determines whether there are any more intervals for all threads (step 834). If there are more intervals for all threads, the performance analyzer 115 selects the next interval from the intervals for all threads (step 835). The performance analyzer 115 then determines whether the end of the first interval is greater than the beginning of the second interval, i.e., whether there is an overlap between the intervals (step 836). If there is an overlap, the end of the second interval becomes the end of the first interval (step 837). The second interval is then removed from the intervals for all threads (step 838). Next, the performance analyzer 115 determines whether there are any more intervals for all threads (step 839). If there are more intervals, the process continues with the next interval at step 835. If there are no more intervals at either step 834 or step 839, the performance analyzer 115 is ready to calculate the total amount of time each of the threads is in the different states during the intervals.

In the example depicted in FIG. 9A, the performance analyzer 115 initially sets the intervals for all threads (intervals_{all threads}) equal to the intervals for Thread₁. Thus, initially, intervals_{all threads}={[t₂, t₅], [t₁₅, t₂₀], [t₂₃, t₂₈], [t₃₃, t₃₆]}. The performance analyzer 115 selects Thread₂ and selects the first interval from Thread₂, i.e., [t₀, t₁₂]. The flag is initialized to 0, and the first interval_{all threads} [t₂, t₅] is selected. The performance analyzer 115 determines that interval_{beginning} for all threads falls between the interval for Thread₂, i.e., t₀<t₂<t₁₂. Thus, interval_{beginning} for all threads is set to equal interval_{beginning} for Thread₂, and intervals_{all threads}={[t₀, t₅], [t₁₅, t₂₀], [t₂₃, t₂₈], [t₃₃, t₃₆]}. The flag is then set to equal 1 to signify that there was an overlap between the intervals resulting in an adjustment for intervals_{all threads}. The performance analyzer 115 then determines that interval_{end} for all threads falls between the interval for Thread₂, i.e., t₀<t₅<t₁₂. Thus, intervalend for all threads is set to equal interval_{end} for Thread₂, and intervals_{all threads}={[t₀, t₁₂], [t₁₅, t₂₀], [t₂₃, t₂₈], [t₃₃, t₃₆]}. The flag is again set to equal 1 to signify that there was an overlap between the intervals resulting in an adjustment for intervals_{all threads}. Thus, the interval for Thread₂ is not added to the intervals_{all threads}. The process continues with the remaining intervals. At the conclusion of this portion of the process, intervals_{all threads}={[t₀, t₂₀], [t₂₂, t₃₆]}.

The performance analyzer 115 begins the next portion of the process by setting the totals for all threads and all states to zero (step 840, FIG. 8F). The process depicted in FIGS. 8F-8H is similar to that depicted in FIGS. 6B-6C. The performance analyzer 115 starts by selecting a thread (step 841). The performance analyzer 115 also selects an interval from the intervals for all threads (step 842). The next step performed by the performance analyzer 115 is to retrieve an event for the selected thread (step 843). Thereafter, the performance analyzer 115 determines whether the beginning of the interval is less than the time stamp of the event (step 844). If the beginning of the interval is less than the time stamp of the event, the performance analyzer 115 retrieves the previous event for the selected thread (step 845). The performance analyzer 115 then sets the beginning of the time period equal to the beginning of the interval (step 846).

If, at step 844, the beginning of the interval is not less than the time stamp of the event, the performance analyzer 115 determines whether the beginning of the interval is equal to the time stamp of the event (step 847). If the beginning of the interval is equal to the time stamp of the event, the process continues at step 846. The performance analyzer 115 then determines whether there are any more events for the selected thread (step 848, FIG. 8G). If there are more events, the performance analyzer 115 stores the state key of the event in the current state (step 849). The performance analyzer 115 then retrieves the next event (step 850).

The next step performed by the performance analyzer 115 is to determine whether the time stamp of the next event is less than the end of the interval (step 851). If the time stamp of the next event is less than the end of the interval, then the end of the time period is set to equal the time stamp of the next event (step 852). The time period (i.e., time period_{end}−time period_{beginning}) is then added to the total for the current state and the selected thread (step 853). The beginning of the time period is then set to equal the end of the time period (step 854). The performance analyzer 115 determines whether there are any more events (step 855). If there are more events, the process continues at step 849. If there are no more events, the performance analyzer 115 sets the end of the time period equal to the end of the interval (step 856). The performance analyzer 115 also performs this step if it determines that the time stamp of the next event was not less than the end of the interval at step 851, i.e., if the event ended after the end of the interval. The time period is then added to the total for the current state and the selected thread (step 857). The performance analyzer 115 determines whether there are any more intervals (step 858). If there are more intervals, the process continues at step 842, FIG. 8F. If there are no more intervals, the performance analyzer 115 determines whether there are any more threads (step 859). If there are more threads, the process continues at step 841. Otherwise, the process ends.

If, at step 848, the performance analyzer 115 determines that there are no more events in the selected thread, the end of the time period is set to equal the time stamp for the end of the selected thread (step 860), and the process continues at step 857. If, at step 847, FIG. 8F, the beginning of the interval is not equal to the time stamp of the event, the performance analyzer 115 determines whether there are any more events for the selected thread (step 861). If there are more events, the process continues at step 843. Otherwise, the performance analyzer 115 sets the beginning of the time period to equal the beginning of the interval (step 862, FIG. 8G), and the process continues at step 856.

If, at step 836, the end of the first interval is not greater than the beginning of the second interval, i.e., there is no overlap in intervals, the performance analyzer 115 determines whether there are any more intervals for all threads (step 863, FIG. 8H). If there are no more intervals, the process continues at step 840. Otherwise, the second interval becomes the first interval (step 864). Also, the next interval for all threads becomes the second interval (step 865), and the process continues at step 836.

Using the example above, after intervals_{all threads} is determined, the performance analyzer 115 is ready to calculate the total amount of time the threads are in various states during these intervals. The events occurring in the threads while any thread is in an anchored state of G is shown by the shaded regions 910 and 912 in FIG. 9B.

If the anchored state is R, as shown in FIG. 9C, the portions 914, 916, and 918 of the events for the threads which fall within the time interval are shown in FIG. 9D. Similarly, if the anchored state is B, as shown in FIG. 9E, the portions 920, 922, and 924 of the events for the threads which fall within the time interval are shown in FIG. 9F. If the performance analyzer 115 were to perform the process depicted in FIGS. 8A-8H on the threads depicted in FIGS. 9A-9F, it would determine the following totals, i.e., the amount of time each thread is in each state while any of the threads is in the anchored state, if G were the anchored state, as depicted in FIGS. 9A and 9B:

| State | Total(Thread₁) | Total(Thread₂) | Total(Thread₃) | Total(Thread₄) |
|---|---|---|---|---|
| G | t₅ − t₂ + t₂₀ − | t₂ − t₀ + t₃ − | t₇ − t₄ + t₁₅ − | t₁₀ − t₅ + t₁₇ − |
| | t₁₅ + t₂₈ − | t₂ + t₆ − t₃ + | t₁₀ + t₂₇ − | t₁₄ + t₁₈ − |
| | t₂₃ + t₃₆ − t₃₃ | t₁₁ − t₆ + t₁₂ − | t₂₄ + t₃₂ − t₂₇ | t₁₇ + t₁₉ − |
| | | t₁₁ + t₁₆ − | | t₁₈ + t₃₃ − t₃₁ |
| | | t₁₃ + t₁₉ − | | |
| | | t₁₆ + t₂₅ − | | |
| | | t₂₂ + t₃₄ − | | |
| | | t₂₉ | | |
| R | t₈ − t₅ + t₂₃ − | t₁₃ − t₁₂ + | t₁₀ − t₇ + t₁₈ − | t₁₃ − t₁₀ + |
| | t₂₂ | t₂₆ − t₂₅ + | t₁₅ + t₂₀ − | t₁₄ − t₁₃ + |
| | | t₂₉ − t₂₆ | t₁₈ + t₃₅ − t₃₂ | t₂₀ − t₁₉ + |
| | | | | t₂₆ − t₂₂ |
| B | t₁₅ − t₈ + t₃₃ − | t₂₀ − t₁₉ | t₂₄ − t₂₂ | t₂₉ − t₂₆ + |
| | t₂₈ | | | t₃₀ − t₂₉ + |
| | | | | t₃₁ − t₃₀ |

If R were the anchored state, as depicted in FIGS. 9C and 9D, the totals would be as follows:

| State | Total(Thread₁) | Total(Thread₂) | Total(Thread₃) | Total(Thread₄) |
|---|---|---|---|---|
| G | t₂₀ − t₁₅ + | t₆ − t₅ + t₁₁ − | t₇ − t₅ + t₁₄ − | t₁₀ − t₅ + t₁₇ − |
| | t₂₈ − t₂₃ + | t₆ + t₁₂ − t₁₁ + | t₁₀ + t₂₇ − | t₁₅ + t₁₈ − |
| | t₃₅ − t₃₃ | t₁₄ − t₁₃ + | t₂₄ + t₂₉ − t₂₇ | t₁₇ + t₁₉ − |
| | | t₁₆ − t₁₅ + | | t₁₈ + t₃₃ − t₃₂ |
| | | t₁₉ − t₁₆ + | | |
| | | t₂₅ − | | |
| | | t₂₂ + t₃₄ − t₃₂ | | |
| R | t₈ − t₅ + t₂₃ − | t₁₃ − t₁₂ + | t₁₀ − t₇ + t₁₈ − | t₁₃ − t₁₀ + |
| | t₂₀ | t₂₆ − t₂₅ + | t₁₅ + t₂₁ − | t₁₄ − t₁₃ + |
| | | t₂₉ − t₂₆ | t₁₈ + t₃₅ − t₃₂ | t₂₆ − t₁₉ |
| B | t₁₄ − t₈ + t₂₉ − | t₂₂ − t₁₉ | t₂₄ − t₂₁ | t₂₉ − t₂₆ |
| | t₂₈ + t₃₃ − t₃₂ | | | |

If B were the anchored state, as depicted in FIGS. 9E and 9F, the totals would be as follows:

| State | Total(Thread₁) | Total(Thread₂) | Total(Thread₃) | Total(Thread₄) |
|---|---|---|---|---|
| G | t₂₀ − t₁₉ + | t₁₁ − t₈ + t₁₂ − | t₁₅ − t₁₀ + | t₁₀ − t₈ + t₁₅ − |
| | t₂₄ − t₂₃ + | t₁₁ + t₁₅ − | t₂₇ − t₂₆ + | t₁₄ + t₃₃ − |
| | t₂₈ − t₂₆ | t₁₃ + t₂₄ − | t₃₂ − t₂₇ | t₃₁ |
| | | t₂₂ + t₃₃ − t₂₉ | | |
| R | t₂₃ − t₂₀ | t₁₃ − t₁₂ + | t₁₀ − t₈ + t₂₁ − | t₁₃ − t₁₀ + |
| | | t₂₉ − t₂₆ | t₁₉ + t₃₃ − | t₁₄ − t₁₃ + |
| | | | t₃₂ | t₂₄ − t₁₉ |
| B | t₁₅ − t₈ + t₃₃ − | t₂₂ − t₁₉ | t₂₄ − t₂₁ | t₂₉ − t₂₆ + |
| | t₂₈ | | | t₃₀ − t₂₉ + |
| | | | | t₃₁ − t₃₀ |

To determine the percentage of time each thread is in a particular state while any thread is in the anchored state, these totals are divided by the sum of the intervals. For example, to determine the percentage of time Thread₁ is in state G while the anchored state is B, Total(Thread₁, G) is divided by the sum of the intervals. Thus,

$$Percentage ( {Thread}_{2} , G ) = \frac{{t}_{20} - {t}_{19} + {t}_{24} - {t}_{23} + {t}_{28} - {t}_{26}}{{t}_{15} - {t}_{8} + {t}_{24} - {t}_{19} + {t}_{33} - {t}_{26}}$$

Conclusion

Methods and systems consistent with the present invention collect performance data from hardware and software components of an application program, allowing a developer to understand how performance data relates to each thread of a program and complementing a developer's ability to understand and subsequently diagnose performance issues occurring in a program.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A method in a data processing system having a program with a plurality of threads having a plurality of states, the method comprising the steps of:
running the program and determining the state of each thread during a measuring period, wherein the measuring period comprises a plurality of time intervals;
receiving user input indicating a selected one of the plurality of states;
receiving user input indicating a selected one of the plurality of threads;
determining a portion of the measuring period during which the selected thread is in the selected state;
determining, during the portion of the measuring period, whether another thread other than the selected thread is in another state other than the selected state; and
when it is determined that the other thread is in the other state, determining an amount of time that the other thread is in the other state.

2. The method of claim 1, further comprising the step of calculating a percent of the portion of the measuring period that constitutes the amount of time that the other thread is in the other state.

3. The method of claim 1, futher comprising the steps of:
determining, during the portion of the measuring period, whether the other thread is in the selected state;
when it is determined that the other thread is in the selected state, determining a second amount of time that the other thread is in the selected state; and
calculating a percent of the portion of the measuring period that constitutes the second amount of time that the other thread is in the selected state.

4. A method in a data processing system having a program with a plurality of threads having a plurality of states, wherein the program executes during a measuring period and the measuring period comprises a plurality of time intervals, the method comprising the steps of:
receiving user input indicating one of the plurality of states to anchor;
receiving user input indicating a selected one of the plurality of threads;
determining a portion of the measuring period during which the selected thread is in the anchored state;
determining, during the portion of the measuring period, whether another thread other than the selected thread is in another state other than the anchored state; and
when it is determined that the other thread is in the other state, determining an amount of time that the other thread is in the other state.

5. The method of claim 4, further comprising the step of calculating a percent of the portion of the measuring period that constitutes the amount of time that the other thread is in the other state.

6. The method of claim 4, further comprising the steps of:
determining, during the portion of the measuring period, whether the other thread is in the anchored state;
when it is determined that the other thread is in the anchored state, determining a second amount of time that the other thread is in the anchored state; and
calculating a percent of the portion of the measuring period that constitutes the second amount of time that the other thread is in the anchored state.

7. A method in a data processing system having a program with a plurality of threads having a plurality of states, wherein the program executes during a measuring period and the measuring period comprises a plurality of time intervals, the method comprising the steps of:
receiving user input indicating a selected one of the plurality of states;
receiving user input indicating a selected one of the plurality of threads; and
determining a portion of the measuring period during which the selected thread is in the selected state.

8. The method of claim 7, further comprising the steps of:
determining, during the portion of the measuring period, whether another thread other than the selected thread is in another state other than the selected state;
when it is determined that the other thread is in the other state, determining an amount of time that the other thread is in the other state; and
calculating a percent of the portion of the measuring period that constitutes the amount of time that the other thread is in the other state.

9. The method of claim 7, further comprising the steps of:
determining, during the portion of the measuring period, whether another thread other than the selected thread is in the selected state;
when it is determined that the other thread is in the selected state, determining an amount of time that the other thread is in the selected state; and
calculating a percent of the portion of the measuring period that constitutes the amount of time that the other thread is in the selected state.

10. A method in a data processing system having a program with a plurality of states, wherein the program executes via a plurality of paths during a measuring period, the method comprising the steps of:
receiving user input indicating a selected one of the plurality of states;
receiving user input indicating a selected one of the plurality of paths of execution; and
determining a portion of the measuring period during which the selected path of execution is in the selected state.

11. A method in a data processing system having a program with a plurality of threads having a plurality of states, the method comprising the steps of:
running the program and determining the state of each thread during a measuring period, wherein the measuring period comprises a plurality of time intervals;
receiving user input indicating a selected one of the plurality of states;
receiving user input indicating a selected one of the plurality of threads;
determining a portion of the measuring period during which the selected thread is in the selected state;
determining, during the portion of the measuring period, whether another thread other than the selected thread is in the selected state; and
when it is determined that the other thread is in the selected state, determining an amount of time that the other thread is in the selected state.

12. The method of claim 11, further comprising the step of calculating a percent of the portion of the measuring period that constitutes the amount of time that the other thread is in the selected state.

13. A method in a data processing system having a program with a plurality of threads having a plurality of states, wherein the program executes during a measuring period and the measuring period comprises a plurality of time intervals, the method comprising the steps of:
receiving user input indicating one of the plurality of states to anchor;
receiving user input indicating a selected one of the plurality of threads;
determining a portion of the measuring period during which the selected thread is in the anchored state;
determining, during the portion of the measuring period, whether another thread other than the selected thread is in the anchored state; and
when it is determined that the other thread is in the anchored state, determining an amount of time that the other thread is in the anchored state.

14. The method of claim 13, further comprising the step of calculating a percent of the portion of the measuring period that constitutes the amount of time that the other thread is in the anchored state.

15. A method in a data processing system having a program with a plurality of threads having a plurality of states, the method comprising the steps of:
running the program and determining the state of each thread during a measuring period, wherein the measuring period comprises a plurality of time intervals;
receiving user input indicating a selected one of the plurality of states;
determining a portion of the measuring period during which any of the plurality of threads is in the selected state;
determining, during the portion of the measuring period, whether a selected one of the plurality of threads is in another state other than the selected state; and
when it is determined that the selected thread is in the other state, determining an amount of time that the selected thread is in the other state.

16. The method of claim 15, further comprising the step of calculating a percent of the portion of the measuring period that constitutes the amount of time that the selected thread is in the other state.

17. The method of claim 15, further comprising the steps of:
determining, during the portion of the measuring period, whether the selected thread is in the selected state;
when it is determined that the selected thread is in the selected state, determining a second amount of time that the selected thread is in the selected state; and
calculating a percent of the portion of the measuring period that constitutes the second amount of time that the selected thread is in the selected state.

18. A method in a data processing system having a program with a plurality of threads having a plurality of states, wherein the program executes during a measuring period and the measuring period comprises a plurality of time intervals, the method comprising the steps of:
receiving user input indicating one of the plurality of states to anchor;
determining a portion of the measuring period during which any of the plurality of threads is in the anchored state;
determining, during the portion of the measuring period, whether a selected one of the plurality of threads is in another state other than the anchored state; and
when it is determined that the selected thread is in the other state, determining an amount of time that the selected thread is in the other state.

19. The method of claim 18, further comprising the step of calculating a percent of the portion of the measuring period that constitutes the amount of time that the selected thread is in the other state.

20. The method of claim 18, further comprising the steps of:
determining, during the portion of the measuring period, whether the selected thread is in the anchored state;
when it is determined that the selected thread is in the anchored state, determining a second amount of time that the selected thread is in the anchored state; and
calculating a percent of the portion of the measuring period that constitutes the second amount of time that the selected thread is in the anchored state.

21. A method in a data processing system having a program with a plurality of threads having a plurality of states, wherein the program executes during a measuring period and the measuring period comprises a plurality of time intervals, the method comprising the steps of:
receiving user input indicating a selected one of the plurality of states; and
determining a portion of the measuring period during which any of the plurality of threads is in the selected state.

22. The method of claim 21, further comprising the steps of:
determining, during the portion of the measuring period, whether a selected one of the plurality of threads is in another state other than the selected state;
when it is determined that the selected thread is in the other state, determining an amount of time that the selected thread is in the other state; and
calculating a percent of the portion of the measuring period that constitutes the amount of time that the selected thread is in the other state.

23. The method of claim 21, further comprising the steps of:
determining, during the portion of the measuring period, whether a selected one of the plurality of threads is in the selected state;
when it is determined that the selected thread is in the selected state, determining an amount of time that the selected thread is in the selected state; and
calculating a percent of the portion of the measuring period that constitutes the amount of time that the selected thread is in the selected state.

24. A method in a data processing system having a program with a plurality of states, wherein the program executes via a plurality of paths during a measuring period, the method comprising the steps of:
receiving user input indicating a selected one of the plurality of states; and
determining a portion of the measuring period during which any of the plurality of paths of execution is in the selected state.

25. A method in a data processing system having a program with a plurality of threads having a plurality of states, the method comprising the steps of:
running the program and determining the state of each thread during a measuring period, wherein the measuring period comprises a plurality of time intervals;
receiving user input indicating a selected one of the plurality of states;
determining a portion of the measuring period during which any of the plurality of threads is in the selected state;
determining, during the portion of the measuring period, whether a selected one of the plurality of threads is in the selected state; and
when it is determined that the selected thread is in the selected state, determining an amount of time that the selected thread is in the selected state.

26. The method of claim 25, further comprising the step of calculating a percent of the portion of the measuring period that constitutes the amount of time that the selected thread is in the selected state.

27. A method in a data processing system having a program with a plurality of threads having a plurality of states, wherein the program executes during a measuring period and the measuring period comprises a plurality of time intervals, the method comprising the steps of:
receiving user input indicating one of the plurality of states to anchor;
determining a portion of the measuring period during which any of the plurality of threads is in the anchored state;
determining, during the portion of the measuring period, whether a selected one of the plurality of threads is in the anchored state; and
when it is determined that the selected thread is in the anchored state, determining an amount of time that the selected thread is in the anchored state.

28. The method of claim 27, further comprising the step of calculating a percent of the portion of the measuring period that constitutes the amount of time that the selected thread is in the anchored state.

29. A computer-readable medium containing instructions for controlling a data processing system to perform a method, the data processing system having a program with a plurality of threads having a plurality of states, the method comprising the steps of:
running the program and determining the state of each thread during a measuring period, wherein the measuring period comprises a plurality of time intervals;
receiving user input indicating a selected one of the plurality of states;
receiving user input indicating a selected one of the plurality of threads;
determining a portion of the measuring period during which the selected thread is in the selected state;
determining, during the portion of the measuring period, whether another thread other than the selected thread is in another state other than the selected state; and
when it is determined that the other thread is in the other state, determining an amount of time that the other thread is in the other state.

30. The computer-readable medium of claim 29, further comprising the step of calculating a percent of the portion of the measuring period that constitutes the amount of time that the other thread is in the other state.

31. The computer-readable medium of claim 29, further comprising the steps of:
determining, during the portion of the measuring period, whether the other thread is in the selected state;
when it is determined that the other thread is in the selected state, determining a second amount of time that the other thread is in the selected state; and
calculating a percent of the portion of the measuring period that constitutes the second amount of time that the other thread is in the selected state.

32. A computer-readable medium containing instructions for controlling a data processing system to perform a method, the data processing system having a program with a plurality of threads having a plurality of states, wherein the program executes during a measuring period and the measuring period comprises a plurality of time intervals, the method comprising the steps of:
receiving user input indicating one of the plurality of states to anchor;
receiving user input indicating a selected one of the plurality of threads;
determining a portion of the measuring period during which the selected thread is in the anchored state;
determining, during the portion of the measuring period, whether another thread other than the selected thread is in another state other than the anchored state; and
when it is determined that the other thread is in the other state, determining an amount of time that the other thread is in the other state.

33. The computer-readable medium of claim 32, further comprising the step of calculating a percent of the portion of the measuring period that constitutes the amount of time that the other thread is in the other state.

34. The computer-readable medium of claim 32, further comprising the steps of:
determining, during the portion of the measuring period, whether the other thread is in the anchored state;
when it is determined that the other thread is in the anchored state, determining a second amount of time that the other thread is in the anchored state; and
calculating a percent of the portion of the measuring period that constitutes the second amount of time that the other thread is in the anchored state.

35. A computer-readable medium containing instructions for controlling a data processing system to perform a method, the data processing system having a program with a plurality of threads having a plurality of states, wherein the program executes during a measuring period and the measuring period comprises a plurality of time intervals, the method comprising the steps of:
receiving user input indicating a selected one of the plurality of states;
receiving user input indicating a selected one of the plurality of threads; and
determining a portion of the measuring period during which the selected thread is in the selected state.

36. The computer-readable medium of claim 35, further comprising the steps of:
determining, during the portion of the measuring period, whether another thread other than the selected thread is in another state other than the selected state;
when it is determined that the other thread is in the other state, determining an amount of time that the other thread is in the other state; and
calculating a percent of the portion of the measuring period that constitutes the amount of time that the other thread is in the other state.

37. The computer-readable medium of claim 35, further comprising the steps of:
determining, during the portion of the measuring period, whether another thread other than the selected thread is in the selected state;
when it is determined that the other thread is in the selected state, determining an amount of time that the other thread is in the selected state; and
calculating a percent of the portion of the measuring period that constitutes the amount of time that the other thread is in the selected state.

38. A computer-readable medium containing instructions for controlling a data processing system to perform a method, the data processing system having a program with a plurality of states, wherein the program executes via a plurality of paths during a measuring period, the method comprising the steps of:
receiving user input indicating a selected one of the plurality of states;
receiving user input indicating a selected one of the plurality of paths of execution; and
determining a portion of the measuring period during which the selected path of execution is in the selected state.

39. A computer-readable medium containing instructions for controlling a data processing system to perform a method, the data processing system having a program with a plurality of threads having a plurality of states, the method comprising the steps of:
running the program and determining the state of each thread during a measuring period, wherein the measuring period comprises a plurality of time intervals;
receiving user input indicating a selected one of the plurality of states;
receiving user input indicating a selected one of the plurality of threads;
determining a portion of the measuring period during which the selected thread is in the selected state;
determining, during the portion of the measuring period, whether another thread other than the selected thread is in the selected state; and
when it is determined that the other thread is in the selected state, determining an amount of time that the other thread is in the selected state.

40. The computer-readable medium of claim 39, further comprising the step of calculating a percent of the portion of the measuring period that constitutes the amount of time that the other thread is in the selected state.

41. A computer-readable medium containing instructions for controlling a data processing system to perform a method, the data processing system having a program with a plurality of threads having a plurality of states, wherein the program executes during a measuring period and the measuring period comprises a plurality of time intervals, the method comprising the steps of:
receiving user input indicating one of the plurality of states to anchor;
receiving user input indicating a selected one of the plurality of threads;
determining a portion of the measuring period during which the selected thread is in the anchored state;
determining, during the portion of the measuring period, whether another thread other than the selected thread is in the anchored state; and
when it is determined that the other thread is in the anchored state, determining an amount of time that the other thread is in the anchored state.

42. The computer-readable medium of claim 41, further comprising the step of calculating a percent of the portion of the measuring period that constitutes the amount of time that the other thread is in the anchored state.

43. A computer-readable medium containing instructions for controlling a data processing system to perform a method, the data processing system having a program with a plurality of threads having a plurality of states, the method comprising the steps of:
running the program and determining the state of each thread during a measuring period, wherein the measuring period comprises a plurality of time intervals;
receiving user input indicating a selected one of the plurality of states;
determining a portion of the measuring period during which any of the plurality of threads is in the selected state;
determining, during the portion of the measuring period, whether a selected one of the plurality of threads is in another state other than the selected state; and
when it is determined that the selected thread is in the other state, determining an amount of time that the selected thread is in the other state.

44. The computer-readable medium of claim 43, further comprising the step of calculating a percent of the portion of the measuring period that constitutes the amount of time that the selected thread is in the other state.

45. The computer-readable medium of claim 43, further comprising the steps of:
determining, during the portion of the measuring period, whether the selected thread is in the selected state;
when it is determined that the selected thread is in the selected state, determining a second amount of time that the selected thread is in the selected state; and
calculating a percent of the portion of the measuring period that constitutes the second amount of time that the selected thread is in the selected state.

46. A computer-readable medium containing instructions for controlling a data processing system to perform a method, the data processing system having a program with a plurality of threads having a plurality of states, wherein the program executes during a measuring period and the measuring period comprises a plurality of time intervals, the method comprising the steps of:
receiving user input indicating one of the plurality of states to anchor;
determining a portion of the measuring period during which any of the plurality of threads is in the anchored state;
determining, during the portion of the measuring period, whether a selected one of the plurality of threads is in another state other than the anchored state; and
when it is determined that the selected thread is in the other state, determining an amount of time that the selected thread is in the other state.

47. The computer-readable medium of claim 46, further comprising the step of calculating a percent of the portion of the measuring period that constitutes the amount of time that the selected thread is in the other state.

48. The computer-readable medium of claim 46, further comprising the steps of:
determining, during the portion of the measuring period, whether the selected thread is in the anchored state;
when it is determined that the selected thread is in the anchored state, determining a second amount of time that the selected thread is in the anchored state; and
calculating a percent of the portion of the measuring period that constitutes the second amount of time that the selected thread is in the anchored state.

49. A computer-readable medium containing instructions for controlling a data processing system to perform a method, the data processing system having a program with a plurality of threads having a plurality of states, wherein the program executes during a measuring period and the measuring period comprises a plurality of time intervals, the method comprising the steps of:
receiving user input indicating a selected one of the plurality of states; and
determining a portion of the measuring period during which any of the plurality of threads is in the selected state.

50. The computer-readable medium of claim 49, further comprising the steps of:
determining, during the portion of the measuring period, whether a selected one of the plurality of threads is in another state other than the selected state;
when it is determined that the selected thread is in the other state, determining an amount of time that the selected thread is in the other state; and
calculating a percent of the portion of the measuring period that constitutes the amount of time that the selected thread is in the other state.

51. The computer-readable medium of claim 49, further comprising the steps of:
determining, during the portion of the measuring period, whether a selected one of the plurality of threads is in the selected state;
when it is determined that the selected thread is in the selected state, determining an amount of time that the selected thread is in the selected state; and
calculating a percent of the portion of the measuring period that constitutes the amount of time that the selected thread is in the selected state.

52. A computer-readable medium containing instructions for controlling a data processing system to perform a method, the data processing system having a program with a plurality of states, wherein the program executes via a plurality of paths during a measuring period, the method comprising the steps of:
receiving user input indicating a selected one of the plurality of states; and
determining a portion of the measuring period during which any of the plurality of paths of execution is in the selected state.

53. A computer-readable medium containing instructions for controlling a data processing system to perform a method, the data processing system having a program with a plurality of threads having a plurality of states, the method comprising the steps of:
running the program and determining the state of each thread during a measuring period, wherein the measuring period comprises a plurality of time intervals;
receiving user input indicating a selected one of the plurality of states;
determining a portion of the measuring period during which any of the plurality of threads is in the selected state;
determining, during the portion of the measuring period, whether a selected one of the plurality of threads is in the selected state; and
when it is determined that the selected thread is in the selected state, determining an amount of time that the selected thread is in the selected state.

54. The computer-readable medium of claim 53, further comprising the step of calculating a percent of the portion of the measuring period that constitutes the amount of time that the selected thread is in the selected state.

55. A computer-readable medium containing instructions for controlling a data processing system to perform a method, the data processing system having a program with a plurality of threads having a plurality of states, wherein the program executes during a measuring period and the measuring period comprises a plurality of time intervals, the method comprising the steps of:
receiving user input indicating one of the plurality of states to anchor;
determining a portion of the measuring period during which any of the plurality of threads is in the anchored state;
determining, during the portion of the measuring period, whether a selected one of the plurality of threads is in the anchored state; and
when it is determined that the selected thread is in the anchored state, determining an amount of time that the selected thread is in the anchored state.

56. The computer-readable medium of claim 55, further comprising the step of calculating a percent of the portion of the measuring period that constitutes the amount of time that the selected thread is in the anchored state.

57. A data processing system comprising:
a memory device further comprising
a target program with a plurality of threads having a plurality of states, wherein the target program executes during a measuring period and the measuring period comprises a plurality of time intervals; and
a monitoring program that receives user input indicating one of the plurality of states to anchor, that receives user input indicating a selected one of the plurality of threads, that determines a portion of the measuring period during which the selected thread is in the anchored state, that determines, during the portion of the measuring period, whether another thread other than the selected thread is in another state other than the anchored state, and when it is determined that the other thread is in the other state, the monitoring program determines an amount of time that the other thread is in the other state; and
a processor for running the target program and the monitoring program.

58. The data processing system of claim 57, wherein the monitoring program further calculates a percent of the portion of the measuring period that constitutes the amount of time that the other thread is in the other state.

59. The data processing system of claim 57, wherein the monitoring program further determines, during the portion of the measuring period, whether the other thread is in the anchored state, when it is determined that the other thread is in the anchored state, the monitoring program determines a second amount of time that the other thread is in the anchored state, and calculates a percent of the portion of the measuring period that constitutes the second amount of time that the other thread is in the anchored state.

60. A data processing system comprising:
a memory device further comprising:
a target program with a plurality of threads having a plurality of states, wherein the target program executes during a measuring period and the measuring period comprises a plurality of time intervals; and
a monitoring program that receives user input indicating a selected one of the plurality of states, that receives user input indicating a selected one of the plurality of threads, and that determines a portion of the measuring period during which the selected thread is in the selected state; and
a processor for running the target program and the monitoring program.

61. The data processing system of claim 60, wherein the monitoring program further determines, during the portion of the measuring period, whether another thread other than the selected thread is in another state other than the selected state, when it is determined that the other thread is in the other state, the monitoring program determines an amount of time that the other thread is in the other state, and calculates a percent of the portion of the measuring period that constitutes the amount of time that the other thread is in the other state.

62. The data processing system of claim 60, wherein the monitoring program further determines, during the portion of the measuring period, whether another thread other than the selected thread is in the selected state, when it is determined that the other thread is in the selected state, the monitoring program determines an amount of time that the other thread is in the selected state, and calculates a percent of the portion of the measuring period that constitutes the amount of time that the other thread is in the selected state.

63. A data processing system comprising:
a memory device further comprising:
a target program with a plurality of threads having a plurality of states, wherein the target program executes during a measuring period and the measuring period comprises a plurality of time intervals; and
a monitoring program that receives user input indicating one of the plurality of states to anchor, that receives user input indicating a selected one of the plurality of threads, that determines a portion of the measuring period during which the selected thread is in the anchored state, that determines, during the portion of the measuring period, whether another thread other than the selected thread is in the anchored state, and when it is determined that the other thread is in the anchored state, the monitoring program determines an amount of time that the other thread is in the anchored state; and
a processor for running the target program and the monitoring program.

64. The data processing system of claim 63, wherein the monitoring program further calculates a percent of the portion of the measuring period that constitutes the amount of time that the other thread is in the anchored state.

65. A data processing system comprising:
a memory device further comprising:
a target program with a plurality of threads having a plurality of states, wherein the target program executes during a measuring period and the measuring period comprises a plurality of time intervals; and
a monitoring program that receives user input indicating one of the plurality of states to anchor, that determines a portion of the measuring period during which any of the plurality of threads is in the anchored state, that determines, during the portion of the measuring period, whether a selected one of the plurality of threads is in another state other than the anchored state, and when it is determined that the selected thread is in the other state, the monitoring program determines an amount of time that the selected thread is in the other state; and
a processor for running the target program and the monitoring program.

66. The data processing system of claim 65, wherein the monitoring program further calculates a percent of the portion of the measuring period that constitutes the amount of time that the selected thread is in the other state.

67. The data processing system of claim 65, wherein the monitoring program further the monitoring program determines, during the portion of the measuring period, whether the selected thread is in the anchored state, when it is determined that the selected thread is in the anchored state, the monitoring program determines a second amount of time that the selected thread is in the anchored state, and calculates a percent of the portion of the measuring period that constitutes the second amount of time that the selected thread is in the anchored state.

68. A data processing system comprising:
a memory device further comprising:
a target program with a plurality of threads having a plurality of states, wherein the target program executes during a measuring period and the measuring period comprises a plurality of time intervals; and
a monitoring program that receives user input indicating a selected one of the plurality of states, and that determines a portion of the measuring period during which any of the plurality of threads is in the selected state; and
a processor for running the target program and the monitoring program.

69. The data processing system of claim 68, wherein the monitoring program further determines, during the portion of the measuring period, whether a selected one of the plurality of threads is in another state other than the selected state, when it is determined that the selected thread is in the other state, the monitoring program determines an amount of time that the selected thread is in the other state, and calculates a percent of the portion of the measuring period that constitutes the amount of time that the selected thread is in the other state.

70. The data processing system of claim 68, wherein the monitoring program further determines, during the portion of the measuring period, whether a selected one of the plurality of threads is in the selected state, when it is determined that the selected thread is in the selected state, the monitoring program determines an amount of time that the selected thread is in the selected state, and calculates a percent of the portion of the measuring period that constitutes the amount of time that the selected thread is in the selected state.

71. A data processing system comprising:
a memory device further comprising:
a target program with a plurality of threads having a plurality of states, wherein the target program executes during a measuring period and the measuring period comprises a plurality of time intervals; and
a monitoring program that receives user input indicating one of the plurality of states to anchor, that determines a portion of the measuring period during which any of the plurality of threads is in the anchored state, that determines, during the portion of the measuring period, whether a selected one of the plurality of threads is in the anchored state, and when it is determined that the selected thread is in the anchored state, the monitoring program determines an amount of time that the selected thread is in the anchored state; and
a processor for running the target program and the monitoring program.

72. The data processing system of claim 71, wherein the monitoring program further calculates a percent of the portion of the measuring period that constitutes the amount of time that the selected thread is in the anchored state.

73. A system having a program with a plurality of states, wherein the program executes via a plurality of paths during a measuring period, the system comprising:
means for receiving user input indicating a selected one of the plurality of states;
means for receiving user input indicating a selected one of the plurality of paths of execution; and
means for determining a portion of the measuring period during which the selected path of execution is in the selected state.
